(19) United States
(12) Patent Application Publication
(10) Pub. No.: US 2015/0105053 A1
(43) Pub. Date: Apr. 16, 2015

(54) FACILITY FOR BLOCKING UNWANTED COMMUNICATION SERVICE

(71) Applicant: Somasundaram Ramkumar, Madurai (IN)

(72) Inventor: Somasundaram Ramkumar, Madurai (IN)

(21) Appl. No.: 14/511,279

(22) Filed: Oct. 10, 2014

Related U.S. Application Data
(60) Provisional application No. 61/889,842, filed on Oct. 11, 2013.

(51) Int. Cl. H04M 3/436; H04L 12/58; H04W 52/02; H04W 8/18; H04W 4/12

(52) U.S. Cl. CPC H04M 3/436; H04W 8/183; H04W 4/12; H04W 52/02; H04L 51/12
USPC 455/412.1; 455/574

(57) ABSTRACT

An electronic device comprising a code comparer connected to the CPU (Central Processing Unit) and operated with integrated chips with low power consumption in a server database of SMS,MMS etc., and also may be operated in a Mobile phone. The code comparer may be operated with Integrated Chips within low power consumption obtained from the battery and/or external power supply in the server database of SMS, MMS etc., and also from battery of the Mobile phone. The code comparer may be used in blocking the unwanted, receiving the wanted, or blocking the unwanted and receiving the wanted SMS, MMS, E-mail, phone calls, voice SMS, voice MMS, fax, voice mail and other modes of communication. This data may be processed by the code comparer by comparing the numbers and/or words of the incoming communication in the memory device of the server database of a communication service center or of a mobile phone.

This application claims the benefit of U.S. Provisional Patent Application Ser. No. 61/889,842, the disclosure of which is incorporated herein by reference.

### FIELD OF THE INVENTION

This disclosure relates to mobile communication generally and, in particular, to SMS (Short Message Service), MMS (Multimedia Service) and other communication services. It is also related to mobile phone, fixed wireless phone and other wireless phone communications.

### BACKGROUND

Today communication by SMS, MMS and so on is being used by every mobile user around the world. Everyday millions of SMS, MMS and so on are sent or received by mobile users within a few seconds. The system of SMS, MMS and so on is quite useful to the mobile users. Meanwhile this SMS, MMS and so on is also being maliciously used by some miscreants. To quote a few wrongful activities—to send SMS, MMS and so on to unknown persons and to create disturbance; to threaten; and to make the operation of the mobile phone dead and other such nuisance. When the mobile phone is switched ON, these disturbances cannot be prevented by the mobile user. These nuisance by SMS, MMS and other mode of communications lead to tension, fatigue, confusion and make the mobile users grow angry in their day to day life. This ultimately spoils their moods and paralyzes their normal work. Hence, the mobile users have been forced to close their operations of their mobile phone.

The purpose of this invention is to blocking the unwanted SMS, MMS, E-mail, phone calls, voice SMS, voice MMS, fax messages, voice mail and other mode of communication which are sent by mobile phone, fixed wireless phone and other communication device, the purpose of this invention is to receiving the wanted SMS, MMS, E-mail, phone calls, voice SMS, voice MMS, fax messages, voice mail and other mode of communication which are sent by mobile phone, fixed wireless phone and other communication device and the purpose of this invention is intended to blocking the unwanted and receiving the wanted SMS, MMS, E-mail, phone calls, voice SMS, voice MMS, fax messages, voice mail and other mode of communication which are sent by mobile phone, fixed wireless phone and other communication device. This invention has all probabilities for blocking the unwanted communication service sent to the mobile users.

### SUMMARY

The object of the invention is an electronic device comprising a code comparer and the said code comparer is connected to the CPU (Central Processing Unit) and said code comparer is operated by the CPU in a server database of SMS, MMS etc., and also in a Mobile phone and said code comparer is to operate with integrated chips within low power consumption obtained from the battery and/or external power supply in the server database of SMS, MMS etc., and also from battery of the Mobile phone and the operation of low power consumption of Integrated chips are operate continuously the function of said code comparer for a very long time and the operation of low power consumption of Integrated chips to save the power consumption of said code comparer in the server database of SMS, MMS etc., and also in the mobile phone and the said code comparer for use in blocking the unwanted, for use in receiving the wanted, for use in blocking the unwanted and receiving the wanted SMS, MMS, E-mail, phone calls, voice SMS, voice MMS, fax, voice mail and other modes of communication which includes cell mail, mobile mail that are sent by mobile phone, fixed wireless phone and other communication devices which includes PDA (Personal Digital Assistant), computer which are being processed by the code comparer by comparing the numbers and/or words of the incoming SMS, MMS, E-mail, phone call, voice SMS, voice MMS, fax, voice mail and other modes of communication which includes cell mail, mobile mail with the already stored numbers and/or words of the SMS, MMS, E-mail, phone call, voice SMS, voice MMS, fax, voice mail and other communication includes cell mail, mobile mail in the memory device of the server database of SMS service center, MMS service center and other communication service center which includes Serving GPRS Support Node (SGSN), Mobile Services Switching Center (MSC), E-mail, phone call, voice SMS, voice MMS, fax, voice mail and including the memory device of the mobile phone handset, fixed wireless phone and other wireless phones which include palm operating system based mobile phone, windows operating system based mobile smart phone. The power supply required to operate the device comprising a code compare in the server database of SMS service center, MMS service center and other communication service center which includes Serving GPRS Support Node (SGSN), Mobile Services Switching Center (MSC), E-mail, phone call, voice SMS, voice MMS, fax, voice mail is obtained from an external power supply. The external power supply may be a battery. The power supply required to operate the device comprising a code comparer in the mobile phone handset, fixed wireless phone and other wireless phones which includes palm operating system based mobile phone, windows operating system based mobile smart phone is obtained from the battery of the mobile phone handset, fixed wireless phone and other wireless phones which includes palm operating system based mobile phone, WINDOWS operating system based mobile smart phone. The other mode of communications can be cell mail, mobile mail and so on. The other communication devices can be PDA, computer and so on. The other communication service center can be Serving GPRS Support Node (SGSN), Mobile Services Switching Center (MSC) and so on. The other wireless phones can be palm operating system based mobile phone, windows operating system based mobile smart phone and so on. The numbers can be mobile phone number, telephone number, fixed wireless phone number and so on. The numbers can be mobile phone number, telephone number, fixed wireless phone number of SMS, MMS, phone call, voice SMS, voice MMS, fax, voice mail. The numbers and/or words can be Email ID. The numbers and/or words can be message of SMS, MMS, E-mail, phone call, voice SMS, voice MMS, fax, voice mail and so on. The numbers and/or words can be any keywords. In order to incorporate this principle there is a need for technological changes in the existing server database of the SMS service center, MMS service center and other communication service center and in the existing mobile phone handset, fixed wireless phone and other wireless phone.

The primary object of this invention is an electronic device comprising a code comparer. The code comparer is connected to the CPU (Central Processing Unit) and operated by the CPU in server database of SMS,MMS etc., and said code comparer is to be operated with integrated chips within low power consumption obtained from the battery and/or external power supply in the server database of SMS,MMS etc., and the operation of low power consumption of integrated chips are operate continuously the function of said code comparer for a very long time and the operation of low power consumption of integrated chips to save the power consumption of said code comparer in the server database of SMS,MMS etc., and the said code comparer for use in blocking the unwanted SMS, MMS, E-mail, phone calls, voice SMS, voice MMS, fax, voice mail and other modes of communication which includes cell mail, mobile mail that are sent by mobile phone, fixed wireless phone and other communication devices which includes PDA (Personal Digital Assistant), computer which are being processed by the code comparer by comparing the numbers and/or words of the incoming SMS, MMS, E-mail, phone call, voice SMS, voice MMS, fax, voice mail and other modes of communication which includes cell mail, mobile mail with the already stored numbers and/or words of the SMS, MMS, E-mail, phone call, voice SMS, voice MMS, fax, voice mail and other communication includes cell mail, mobile mail in the memory device of the server database of SMS service center, MMS service center and other communication service center which includes Serving GPRS Support Node (SGSN), Mobile Services Switching Center (MSC), E-mail, phone call, voice SMS, voice MMS, fax, voice mail which can be deleted in the server database of SMS service center, MMS service center and other communication service center.

Another object of this invention is an Electronic device comprising a code comparer and the said code comparer is connected to the CPU (Central Processing Unit) and said code comparer is operated by CPU in the Mobile phone and said code comparer is to operated with Integrated Chips within low power consumption obtained from the battery of the Mobile phone and the operation of low power consumption of Integrated Chips are operate continuously the function of said code comparer for a very long time and the operation of low power consumption of Integrated Chips to save the power consumption of said code comparer in the mobile phone and the said code comparer for use in blocking the unwanted SMS, MMS, E-mail, phone calls, voice SMS, voice MMS, fax, voice mail and other modes of communication which includes cell mail, mobile mail that are sent by mobile phone, fixed wireless phone and other communication devices which includes PDA (Personal Digital Assistant), computer which are being processed by the code comparer by comparing the numbers and/or words of the incoming SMS, MMS, E-mail, phone call, voice SMS, voice MMS, fax, voice mail and other modes of communication which includes cell mail, mobile mail with the already stored unwanted numbers and/or words of the SMS, MMS, E-mail, phone call, voice SMS, voice MMS, fax, voice mail and other communication includes cell mail, mobile mail in the memory device of the mobile phone handset, fixed wireless phone and other wireless phones which include palm operating system based mobile phone, windows operating system based mobile smart phone which can deleted in the mobile phone handset, fixed wireless phone and other wireless phone.

Another object of this invention is an Electronic device comprising a code comparer and the said code comparer is connected to the CPU (Central Processing Unit) and said code comparer is operated by CPU in server database of SMS,MMS etc., and said code comparer is to operated with Integrated Chips within low power consumption obtained from the battery and/or external power supply in the server database of SMS,MMS etc., and the operation of low power consumption of Integrated Chips are operate continuously the function of said code comparer for a very long time and the operation of low power consumption of Integrated Chips to save the power consumption of said code comparer in the server database of SMS,MMS etc., and the said code comparer for use in receiving the wanted SMS, MMS, E-mail, phone calls, voice SMS, voice MMS, fax, voice mail and other modes of communication which includes cell mail, mobile mail that are sent by mobile phone, fixed wireless phone and other communication devices which includes PDA (Personal Digital Assistant), computer which are being processed by the code comparer by comparing the numbers and/or words of the incoming SMS, MMS, E-mail, phone call, voice SMS, voice MMS, fax, voice mail and other modes of communication which includes cell mail, mobile mail with the already stored wanted numbers and/or words of the SMS, MMS, E-mail, phone call, voice SMS, voice MMS, fax, voice mail and other communication includes cell mail, mobile mail in the memory device of the server database of SMS service center, MMS service center and other communication service center which includes Serving GPRS Support Node (SGSN), Mobile Services Switching Center (MSC), E-mail, phone call, voice SMS, voice MMS, fax, voice mail which can accepted in the server database of SMS service center, MMS service center and other communication service center.

Another object of this invention is an Electronic device comprising a code comparer and the said code comparer is connected to the CPU (Central Processing Unit) and said code comparer is operated by CPU in the Mobile phone and said code comparer is to operated with Integrated Chips within low power consumption obtained from the battery of the Mobile phone and the operation of low power consumption of Integrated Chips are operate continuously the function of said code comparer for a very long time and the operation of low power consumption of Integrated Chips to save the power consumption of said code comparer in the mobile phone and the said code comparer for use in receiving the wanted SMS, MMS, E-mail, phone calls, voice SMS, voice MMS, fax, voice mail and other modes of communication which includes cell mail, mobile mail that are sent by mobile phone, fixed wireless phone and other communication devices which includes PDA (Personal Digital Assistant), computer which are being processed by the code comparer by comparing the numbers and/or words of the incoming SMS, MMS, E-mail, phone call, voice SMS, voice MMS, fax, voice mail and other modes of communication which includes cell mail, mobile mail with the already stored wanted numbers and/or words of the SMS, MMS, E-mail, phone call, voice SMS, voice MMS, fax, voice mail and other communication includes cell mail, mobile mail in the memory device of the mobile phone handset, fixed wireless phone and other wireless phones which include palm operating system based mobile phone, windows operating system based mobile smart phone which can accepted in the mobile phone handset, fixed wireless phone and other wireless phone.

Another object of this invention is an Electronic device comprising a code comparer and the said code comparer is connected to the CPU (Central Processing Unit) and said code comparer is operated by CPU in server database of SMS,MMS etc., and said code comparer is to operated with Integrated Chips within low power consumption obtained from the battery and/or external power supply in the server database of SMS, MMS etc., and the operation of low power consumption of Integrated Chips are operate continuously the function of said code comparer for a very long time and the operation of low power consumption of Integrated Chips to save the power consumption of said code comparer in the server database of SMS, MMS etc., and the said code comparer for use in blocking the unwanted and receiving the wanted SMS, MMS, E-mail, phone calls, voice SMS, voice MMS, fax, voice mail and other modes of communication which includes cell mail, mobile mail that are sent by mobile phone, fixed wireless phone and other communication devices which includes PDA (Personal Digital Assistant), computer which are being processed by the code comparer by comparing the numbers and/or words of the incoming SMS, MMS, E-mail, phone call, voice SMS, voice MMS, fax, voice mail and other modes of communication which includes cell mail, mobile mail with the already stored unwanted and wanted numbers and/or words of the SMS, MMS, E-mail, phone call, voice SMS, voice MMS, fax, voice mail and other communication includes cell mail, mobile mail in the memory device of the server database of SMS service center, MMS service center and other communication service center which includes Serving GPRS Support Node (SGSN), Mobile Services Switching Center (MSC), E-mail, phone call, voice SMS, voice MMS, fax, voice mail which can deleted and accepted in the server database of SMS service center, MMS service center and other communication service center.

Another object of this invention is an electronic device comprising a code comparer connected to the CPU (Central Processing Unit) and operated by the CPU in the mobile phone. The code comparer is operated with integrated chips within low power consumption obtained from the battery of the mobile phone and the operation of low power consumption of integrated chips operate continuously the function of said code comparer for a very long time and the operation of low power consumption of integrated chips to save the power consumption of said code comparer in the mobile phone and the said code comparer for use in blocking the unwanted and receiving the wanted SMS, MMS, E-mail, phone calls, voice SMS, voice MMS, fax, voice mail and other modes of communication which includes cell mail, mobile mail that are sent by mobile phone, fixed wireless phone and other communication devices which includes PDA (Personal Digital Assistant), computer which are being processed by the code comparer by comparing the numbers and/or words of the incoming SMS, MMS, E-mail, phone call, voice SMS, voice MMS, fax, voice mail and other modes of communication which includes cell mail, mobile mail with the already stored unwanted and wanted numbers and/or words of the SMS, MMS, E-mail, phone call, voice SMS, voice MMS, fax, voice mail and other communication includes cell mail, mobile mail in the memory device of the mobile phone handset, fixed wireless phone and other wireless phones which include palm operating system based mobile phone, windows operating system based mobile smart phone which can deleted and accepted in the mobile phone handset, fixed wireless phone and other wireless phone.

### BRIEF DESCRIPTION OF THE DRAWING FIGURES

FIGS. 1-3 illustrate the details of the disclosed embodiments.

### DETAILED DESCRIPTION

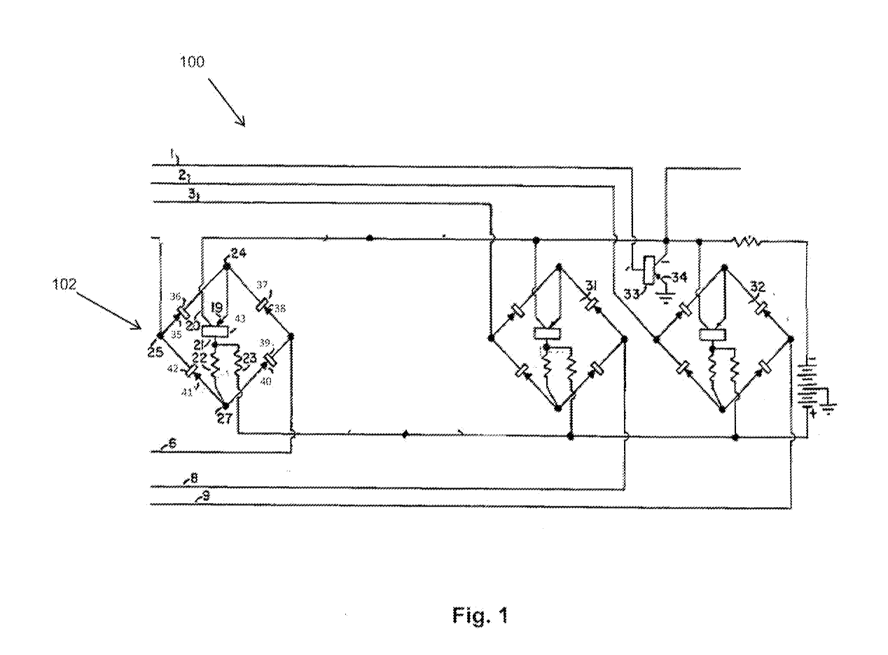

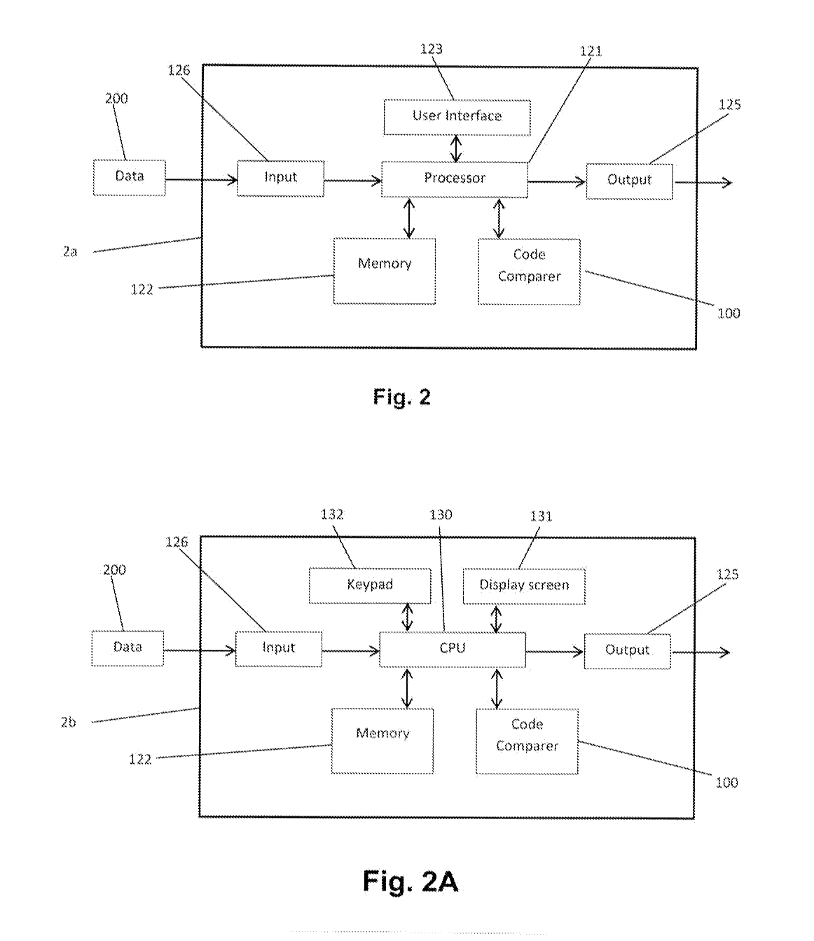

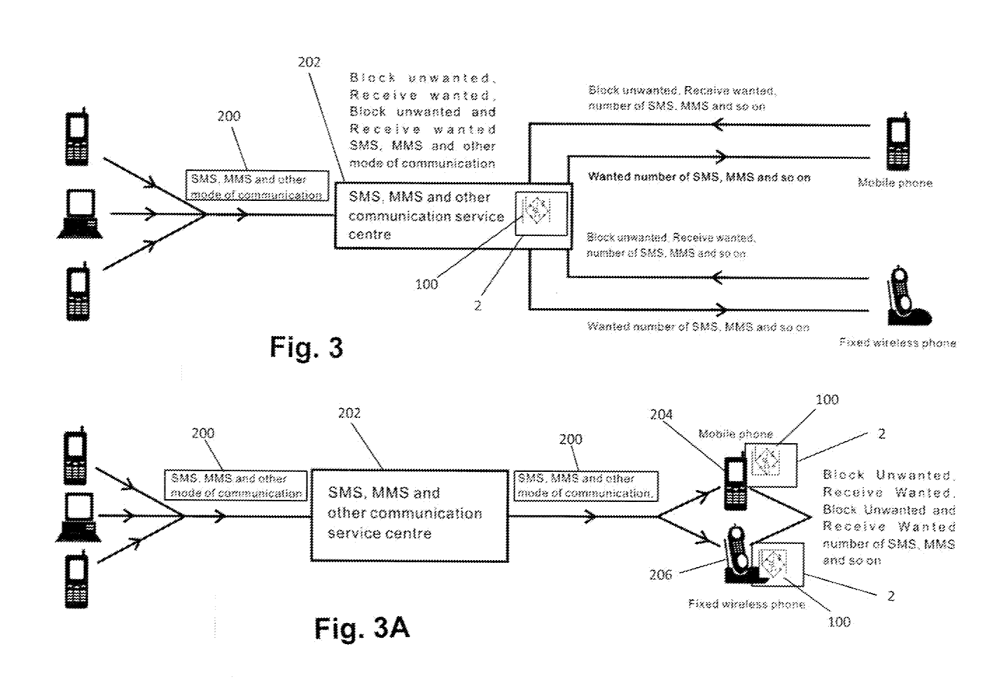

The following points further relate to the invention which may be an electronic device 2a, 2b comprising a code comparer 10. Reference is made to FIGS. 1, 2(a), 2(b), 3(a), and 3(b), herein.
1) As shown in FIG. 1, the said code comparer 100 may comprise a plurality of transistors 13, diodes 12, and/or resistors 14.
2) The said transistors 13 may have pins, namely, a base, emitter and collector.
3) The said code comparer 10 may be operated by a plurality of transistors, diodes, resistors.
4) The plurality of transistors, diodes, resistors may be electrically connected together to operate the code comparer.
5) The code comparer may comprise one or more bridge circuits 11 which may include a transistors, diodes, resistors.
6) A plurality of bridge circuits 11 may comprise a plurality of transistors, diodes, resistors.
7) The said code comparer 10 may be operated by bridge circuits comprising a plurality of transistors, diodes, resistors.
8) The plurality of bridge circuits 11 may comprise a plurality of transistors, diodes, resistors that may be electrically connected together to operate the code comparer.
9) The plurality of bridge circuits 11 may comprise four bridge circuits which may be used for a four bit code system, which can represent up to 16 different characters.
10) The plurality of bridge circuits may comprise six bridge circuits which may be used for a six bit code system, which can represent up to 64 different characters.
11) The said code comparer 10 may be configured to compare the said characters which may be represented by numbers and/or words in a four bit binary code or six bit binary code or more binary code.
12) The power supply may be given to the transistors, diodes, resistors of a code comparer.
13) The power supply may be given to the code comparer comprising a plurality of transistors, diodes, resistors.
14) The power supply may be given to the plurality of transistors, diodes, resistors which are electrically connected together to operate the code comparer.
15) The power supply may be given to the bridge circuits comprising a plurality of transistors, diodes, resistors of a code comparer.
16) The power supply may be given to the plurality of bridge circuits comprising a plurality of transistors, diodes, resistors which are electrically connected together to operate the code comparer.
17) The plurality of transistors of a code comparer may be designed to operate within low power consumption obtained from the battery and/or external power supply in the server database 202 of SMS service center, MMS service center and other communication service center.
18) The plurality of transistors of a code comparer may be designed to operate within low power consumption obtained from the battery of a mobile phone handset 204, a fixed wireless phone 206 and other wireless phones.
19) The operation of low power consumption of the plurality of transistors may continuously operate the function of said code comparer for a very long time and the operation of low power consumption of the plurality of transistors may save or reduce the power consumption of said code comparer in the server database 202 of SMS service center, MMS service center and other communication service center and also in the mobile phone handset 204, fixed wireless phone 206 and other wireless phones.
20) The said code comparer may be operated with integrated chips within low power consumption obtained from the battery and/or external power supply in the server database 202 of SMS service center, MMS service center and other communication service center.
21) The said code comparer may be operated with integrated chips within low power consumption obtained from the battery of mobile phone handset 204, fixed wireless phone 206 and other wireless phones.
22) The operation of low power consumption of integrated chips may continuously operate the function of said code comparer for a very long time and the operation of low power consumption of the integrated chips may save or reduce the power consumption of said code comparer in the server database 202 of SMS service center, MMS service center and other communication service center and also in the mobile phone handset 204, fixed wireless phone 206 and other wireless phones.
23) The particular bridge circuits may be operated by a switching circuit by switching off certain of the bridge circuits of a total plurality of bridge circuits of a code comparer by the given input of characters, which can save the power consumption of said code comparer in the server database 202 of SMS service center, MMS service center and other communication service center and also in the mobile phone handset 204, fixed wireless phone 206 and other wireless phones.
24) The particular transistors, diodes, resistors may be operated by a switching circuit by switching off certain of the plurality of transistors, diodes, resistors of a total plurality of transistors, diodes, resistors of a code comparer by the given input of characters, which can save the power consumption of said code comparer in the server database 202 of SMS service center, MMS service center and other communication service center (e.g. FIG. 3(a)) and also in the mobile phone handset 204, fixed wireless phone 206 and other wireless phones (e.g. FIG. 3(b)).
25) As shown in FIG. 2(a), the said code comparer 100 of the device 2 may be connected to the CPU (Central Processing Unit) and said code comparer 100 may be operated by the CPU in the server database 202 of SMS service center, MMS service center and other communication service center.
26) As shown in FIGS. 2(b) and 3(b), the said code comparer 100 may be connected to the CPU (Central Processing Unit) 130 and said code comparer may be operated by the CPU in the mobile phone handset 204, fixed wireless phone 206 and other wireless phones.
27) As shown in FIGS. 2(a) and 3(a), the said server database 202 may comprise a processor 121 wherein the processor comprises an arithmetic logic unit, a plurality of different registers and control circuits; the server database 202 may comprise a memory device 122 wherein computer-readable information, programs or user data can be stored which may be connected to the processor 121, and the memory device may be configured to accept both reading and writing functions, namely Random Access Memory, RAM; the server may comprise an interface unit which comprises an input unit 126 and/or output unit 125; the input unit 126 may be configured for receiving data 200 of the numbers and/or words of the incoming SMS, MMS, E-mail, phone call, voice SMS, voice MMS, fax, voice mail and other modes of communication which includes cell mail, mobile mail, and the received data 200 from the input may be transferred to be processed by the code comparer 100 of the processor 121 in the server database 202; the output unit 125 may be configured to transfer the data 200 from the processor 121 of the server 202 of SMS service center, MMS service center and other communication service center of respective mobile service provider to the respective mobile phone handset 204, fixed wireless phone 206 and other wireless phones.
28) The server 202 may comprise a user interface unit 123 and the said user interface unit may comprise a keyboard, a touch screen, a microphone and/or a speaker; the user interface unit 123 can receiving data and/or control commands from the user of the server of SMS service center, MMS service center and other communication service center of respective mobile service provider; the processor 121, memory device 122, interface unit 124, user interface unit 123 may be electrically connected to sequentially execute the received data and/or stored data or information in the server, where said execution may be accomplished in accordance with predetermined and substantially pre-programmed operational sequences, and wherein the code comparer 100 may be configured for use in blocking the unwanted, receiving the wanted, or blocking the unwanted and receiving the wanted SMS, MMS, E-mail, phone calls, voice SMS, voice MMS, fax, voice mail and other modes of communication which includes cell mail, mobile mail in the server database 202.
29) With reference to FIGS. 2(b) and 3(b), the said mobile phone handset 204, fixed wireless phone 206 and other wireless phones may comprise a CPU (Central Processing Unit) 130; the mobile phone handset 204, fixed wireless phone 206 and other wireless phones may further comprise the device 2b, including a memory device 122 wherein programs or user data can be stored which is connected to the CPU (Central Processing Unit) and the memory device can accept both reading and writing functions such as RAM; the device 2b may further comprise a CPU comprising an input unit 126 and/or output unit 125; the input unit 126 may be configured for receiving data 200 of the numbers and/or words of the incoming SMS, MMS, E-mail, phone call, voice SMS, voice MMS, fax, voice mail and other modes of communication which includes cell mail, mobile mail and the received data 200 with the input may be transferred to be processed by the code comparer 100 of the CPU in the mobile phone handset 204, fixed wireless phone 206 and other wireless phones; the output unit 125 and/or the CPU may be configured to transfer the data between the CPU and the Display Screen 131 and the keypad 132 of the mobile phone handset 204, fixed wireless phone 206 and other wireless phones.
30) The said code comparer 100 may be configured for use in blocking the unwanted, for use in receiving the wanted, or for use in blocking the unwanted and receiving the wanted SMS, MMS, E-mail, phone calls, voice SMS, voice MMS, fax, voice mail and other modes of communication which includes cell mail and mobile mail that are sent by mobile phone, fixed wireless phone and other communication devices which includes PDA (Personal Digital Assistant), and/or a computer. Said SMS, MMS, E-mail, phone calls, voice SMS, voice MMS, fax, voice mail and other modes of communication may be processed by the code comparer 100 by comparing the numbers and/or words of the incoming SMS, MMS, E-mail, phone call, voice SMS, voice MMS, fax, voice mail and other modes of communication with the already stored numbers and/or words of the SMS, MMS, E-mail, phone call, voice SMS, voice MMS, fax, voice mail and other communication includes cell mail, mobile mail in the memory device 122 of the server database 202 of SMS service center, MMS service center and/or other communication service center which includes Serving GPRS Support Node (SGSN), Mobile Services Switching Center (MSC), E-mail, phone call, voice SMS, voice MMS, fax, voice mail, or in the memory device of the mobile phone handset 204, fixed wireless phone 206 and other wireless phones which include palm operating system based mobile phone, windows operating system based mobile smart phone.
31) The functions of the code comparer can be implemented in the cloud service or cloud computing.
   (I) This invention provides means of blocking the unwanted SMS, MMS, E-mail, phone call, voice SMS, voice MMS, fax, voice mail and other mode of communication:

1) in the server database of SMS service center, MMS service center and other communication service center;

2) in the mobile phone handset, fixed wireless phone and other wireless phone.

1. This invention provides means of blocking the unwanted SMS, MMS, E-mail, phone call, voice SMS, voice MMS, fax, voice mail and other mode of communication in the server database of SMS service center, MMS service center and other communication service center.

### 1. A) Means of Blocking the Unwanted SMS, MMS, E-Mail, Fax

A mobile user can send the unwanted numbers and/or words of the SMS, MMS, E-mail, fax using SMS or any other suitable settings from the mobile phone, fixed wireless phone and other wireless phone to the server database of SMS service center, MMS service center and other communication service center through the respective mobile service provider. A mobile user can send more than one unwanted numbers and/or words of the SMS, MMS, E-mail, fax from the mobile phone, fixed wireless phone and other wireless phone to the server database of SMS service center, MMS service center and other communication service center. The unwanted numbers and/or words of the SMS, MMS, E-mail, fax that are sent remain unchanged in the server database of SMS service center, MMS service center and other communication service center until the mobile user changes the already stored unwanted numbers and/or words of the SMS, MMS, E-mail, fax. The SMS service center, MMS service center and other communication service center sends the unwanted numbers and/or words of the SMS, MMS, E-mail, fax to the server database of the SMS, MMS and so on. Then the unwanted numbers and/or words of the SMS, MMS, E-mail, fax are stored in the memory device of the respective server database.

The SMS, MMS, E-mail, fax message receiver receives the numbers and/or words of the incoming SMS, MMS, E-mail, fax sent by a sender. Sender means a person who sends the SMS, MMS, E-mail, fax to a known or an unknown person. Then the numbers and/or words of the incoming SMS, MMS, E-mail, fax are sent to the code comparer of the respective server database. The code comparer compares the numbers and/or words of the incoming SMS, MMS, E-mail, fax sent by a sender, with the unwanted numbers and/or words of the SMS, MMS, E-mail, fax, that are already stored in the memory device, which are sent from the mobile phone, fixed wireless phone and other wireless phone by the mobile user. The unwanted numbers and/or words of the SMS, MMS, E-mail, fax sent from the mobile phone, fixed wireless phone and other wireless phone by the mobile user are stored in the code comparer memory device.

The numbers can be a mobile phone number, telephone number, fixed wireless phone number and so on. The numbers can be mobile phone number, telephone number, fixed wireless phone number of SMS, MMS, phone call, fax. The numbers and/or words can be Email ID. The numbers and/or words can be message of SMS, MMS, E-mail, fax. The numbers and/or words can be any keywords.

An electronic device comprising a code comparer and the said code comparer is connected to the CPU (Central Processing Unit) and said code comparer is operated by CPU in server database of SMS, MMS etc., and said code comparer is to operate with integrated chips within low power consumption obtained from the battery and/or external power supply in the server database of SMS, MMS etc., and the operation of low power consumption of Integrated Chips are operate continuously the function of said code comparer for a very long time and the operation of low power consumption of Integrated Chips to save the power consumption of said code comparer in the server database of SMS, MMS etc. The power supply required to operate the device comprising a code compare in the server database of SMS service center, MMS service center and other communication service center which includes Serving GPRS Support Node (SGSN), Mobile Services Switching Center (MSC), E-mail, phone call, voice SMS, voice MMS, fax, voice mail is obtained from an external power supply. The external power supply may be a battery.

If the numbers and/or words that is compared in the code comparer are same, then the numbers and/or words of the incoming SMS, MMS, E-mail, fax is blocked or deleted in the respective server database, the message “Not delivered to” is sent to the sender. If the numbers and/or words that is compared in the code comparer is different, then the numbers and/or words of the incoming SMS, MMS, E-mail, fax is sent to the respective number, the message “Delivered to” is sent to the sender. The mobile user can remove the unwanted numbers and/or words of the SMS, MMS, E-mail, fax that are already stored in the memory device of the server database of SMS service center, MMS service center and other communication service center, then the numbers and/or words of the incoming SMS, MMS, E-mail, fax that are received from the sender which is related to that removed unwanted numbers and/or words of the SMS, MMS, E-mail, fax in the memory device of the server database of SMS service center, MMS service center and other communication service center can be sent to the mobile user. Every mobile user has the facility to block the unwanted numbers and/or words of the respective mobile service provider.

The server is integrated into the SMG, MSC and code comparer. The server database is designed suitably to delete unwanted numbers and/or words of the incoming SMS, MMS, E-mail, fax received from the sender. A device comprising a code comparer is designed suitably for comparing the numbers and/or words of the incoming SMS, MMS, E-mail, fax with the already stored unwanted numbers and/or words of the SMS, MMS, E-mail, fax in the memory device of the server database of SMS service center, MMS service center and other communication service. The memory device is designed suitably for storing huge numbers and/or words.

Further if a mobile user wants to block the unwanted numbers and/or words the person can also contact the customer care operator or the network operator and inform them of blocking the unwanted numbers and/or words of SMS, MMS and other mode of communication.

In response to the contact and the information passed on to the network operator concerning blocking the unwanted numbers and/or words of SMS, MMS and other mode of communication of the mobile user the network operator can directly enter the entries of the unwanted numbers and/or words of SMS, MMS and so on to the server database of respective service center viz. the SMS service center, MMS service center and so on.

Also the network operator can enter more than one entry of the unwanted numbers and/or words of SMS, MMS and so on to the respective server database.

In addition, the network operator can delete the unwanted numbers and/or words of SMS, MMS and so on which have been already stored in the respective SMS server database, MMS server database and so on.

Further the numbers and/or words of the incoming SMS, MMS and so on which are blocked in the server database of respective service center cannot be sent to the mobile user. The unwanted numbers and/or words can be removed from the stored entries of the respective server database by the instructions of the mobile user to the network operator. Based on the removal of the unwanted numbers and/or words, the numbers and/or words of the incoming SMS, MMS and so on can be sent to the mobile user.

### 1. b) Means of Blocking the Unwanted Voice Mail

Whenever a caller of any telecommunication instrument attempts to contact a person who has a mobile handset with a facility of voice mail box the code comparer compares the numbers and/or words of any telecommunication instrument of the call received with the unwanted numbers and/or words stored by the user of the mobile phone handset in the memory device of the voice mail server database.

In the common use of the mobile phone handset there is no facility to store the unwanted numbers and/or words specified by the user of mobile phone handset in the voice mail server database.

In order to incorporate this feature of blocking the unwanted voice mail from any caller there is a dire need for implementing other arrangements to store the unwanted numbers and/or words in the memory device of the voice mail server database as specified by the user of the mobile phone handset and also to compare the unwanted numbers and/or words in the code comparer of the voice mail server database and to block the voice mail message that is sent to the mobile user.

The numbers can be a mobile phone number, telephone number, fixed wireless phone number and so on. The numbers can be mobile phone number, telephone number, fixed wireless phone number of voice mail. The numbers and/or words can be message of SMS, phone call and so on. The numbers and/or words can be any keywords.

When a caller attempts the option of sending the message by a voice mail the numbers and/or words of the caller is being compared at that moment in the code comparer of the voice mail server database. If the numbers and/or words of the caller are found the same of the numbers and/or words specified and stored in the memory device of the voice mail server database by the mobile phone user, the message sent by the voice mail box is blocked. The message by the voice mail of the caller becomes dead ultimately. If the numbers and/or words of the caller are not found the same of the numbers and/or words specified and stored in the memory device of the voice mail server database by the mobile phone user, the message sent by the voice mail box is sent to the mobile user. The message by the voice mail of the caller becomes active ultimately.

### 1. c) Means of Blocking the Unwanted Incoming Phone Calls

Whenever a caller of any telecommunication instrument attempts to contact a person the code comparer compares the numbers of any telecommunication instrument of the call received with the unwanted numbers that are stored by the user of the mobile phone handset in the memory device of the respective server database.

In the common use of the mobile phone handset there is no facility to store the unwanted numbers specified by the user of mobile phone handset in the respective server database.

In order to incorporate this feature of blocking the unwanted incoming call from any caller there is a dire need for implementing other arrangements to store the unwanted numbers in the memory device of the respective server database as specified by the user of the mobile phone handset and also to compare the unwanted numbers in the code comparer of the respective server database and to block the incoming call that is sent to the mobile user.

The numbers can be a mobile phone number, telephone number, fixed wireless phone number and so on. The numbers can be any keywords.

When a caller attempts the option of call the numbers of the caller is being compared at that moment in the code comparer of the respective server database. If the numbers of the caller is found the same of the numbers specified and stored in the memory device of the respective server database by the mobile phone user, the incoming call is blocked. The incoming call of the caller becomes dead ultimately. If the numbers of the caller is not found the same of the numbers specified and stored in the memory device of the respective server database by the mobile phone user, the incoming call is sent to the mobile user. The incoming call of the caller becomes active ultimately.

### 1. d) Means of Blocking the Unwanted Voice SMS

Whenever a caller of any telecommunication instrument attempts to contact a person who has a mobile handset with a facility of voice SMS the code comparer compares the numbers and/or words of any telecommunication instrument of the call received with the unwanted numbers and/or words that are stored by the user of the mobile phone handset in the memory device of the voice SMS server database.

In the common use of the mobile phone handset there is no facility to store the unwanted numbers and/or words specified by the user of mobile phone handset in the voice SMS server database.

In order to incorporate this feature of blocking the unwanted voice SMS from any caller there is a dire need for implementing other arrangements to store the unwanted numbers and/or words in the memory device of the voice SMS server database as specified by the user of the mobile phone handset and also to compare the unwanted numbers and/or words in the code comparer of the voice SMS server database and to block the voice SMS that is sent to the mobile user.

The numbers can be a mobile phone number, telephone number, fixed wireless phone number and so on. The numbers can be mobile phone number, telephone number, fixed wireless phone number of voice SMS. The numbers and/or words can be message of SMS, phone call and so on. The numbers and/or words can be any keywords.

When a caller attempts the option of sending the message by a voice SMS the numbers and/or words of the caller is being compared at that moment in the code comparer of the voice SMS server database. If the numbers and/or words of the caller is found the same of the numbers and/or words specified and stored in the memory device of the voice SMS server database by the mobile phone user, the message sent by the voice SMS is blocked. The message by the voice SMS of the caller becomes dead ultimately. If the numbers and/or words of the caller is not found the same of the numbers and/or words specified and stored in the memory device of the voice SMS server database by the mobile phone user, the message sent by the voice SMS is sent to the mobile user. The message by the voice SMS of the caller becomes active ultimately.

### 1. e) Means of Blocking the Unwanted Voice MMS

Whenever a caller of any telecommunication instrument attempts to contact a person who has a mobile handset with a facility of voice MMS the code comparer compares the numbers and/or words of any telecommunication instrument of the call received with the unwanted numbers and/or words that are stored by the user of the mobile phone handset in the memory device of the voice MMS server database.

In the common use of the mobile phone handset there is no facility to store the unwanted numbers and/or words specified by the user of mobile phone handset in the voice MMS server database.

In order to incorporate this feature of blocking the unwanted voice MMS from any caller there is a dire need for implementing other arrangements to store the unwanted numbers and/or words in the memory device of the voice MMS server database as specified by the user of the mobile phone handset and also to compare the unwanted numbers and/or words in the code comparer of the voice MMS server database and to block the voice MMS that is sent to the mobile user.

The numbers can be a mobile phone number, telephone number, fixed wireless phone number and so on. The numbers can be mobile phone number, telephone number, fixed wireless phone number of voice MMS. The numbers and/or words can be message of SMS, phone call and so on. The numbers and/or words can be any keywords.

When a caller attempts the option of sending the message by a voice MMS the numbers and/or words of the caller is being compared at that moment in the code comparer of the voice MMS server database. If the numbers and/or words of the caller is found the same of the numbers and/or words specified and stored in the memory device of the voice MMS server database by the mobile phone user, the message sent by the voice MMS is blocked. The message by the voice MMS of the caller becomes dead ultimately. If the numbers and/or words of the caller is not found the same of the numbers and/or words specified and stored in the memory device of the voice MMS server database by the mobile phone user, the message sent by the voice MMS is sent to the mobile user. The message by the voice MMS of the caller becomes active ultimately.

2. This invention provides means of blocking the unwanted SMS, MMS,
E-mail, phone call, voice SMS, voice MMS, fax, voice mail and other mode of communication in Mobile phone handset, Fixed wireless phone and other wireless phone.

The user stores unwanted numbers and/or words of the SMS, MMS, E-mail, phone call, voice SMS, voice MMS, fax, voice mail and so on in the memory device of the mobile phone handset, fixed wireless phone and other wireless phone through the option—“Menu”.

In order to store an unwanted numbers and/or words of the SMS, MMS, E-mail, phone call, voice SMS, voice MMS, fax, voice mail and so on, the user selects the Menu of the mobile phone handset, fixed wireless phone and other wireless phone, for example—Message Menu is opened by the user. The Message Menu has Sub-Menu—for example “Block Unwanted Numbers and/or Words”—viz. unwanted numbers and/or words of the SMS, MMS, E-mail, phone call, voice SMS, voice MMS, fax, voice mail and so on. The user selects the option Sub-Menu and enters the unwanted numbers and/or words of the SMS, MMS, E-mail, phone call, voice SMS, voice MMS, fax, voice mail and so on. The user can enter more than one unwanted numbers and/or words of the SMS, MMS, E-mail, phone call, voice SMS, voice MMS, fax, voice mail and so on in the Sub-Menu. The unwanted numbers and/or words of the SMS, MMS, E-mail, phone call, voice SMS, voice MMS, fax, voice mail and so on that are entered in the Sub-Menu are stored in the memory device of the mobile phone handset, fixed wireless phone and other wireless phone. The unwanted numbers and/or words of the SMS, MMS, E-mail, phone call, voice SMS, voice MMS, fax, voice mail and so on that are stored remain unchanged in the Sub-Menu, until the user changes the unwanted numbers and/or words of the SMS, MMS, E-mail, phone call, voice SMS, voice MMS, fax, voice mail and so on that are already stored in the Sub-Menu. The user can also remove the unwanted numbers and/or words of the SMS, MMS, E-mail, phone call, voice SMS, voice MMS, fax, voice mail and so on that are already stored in the memory device of the mobile phone handset, fixed wireless phone and other wireless phone. A security code or lock code is provided to protect the unwanted numbers and/or words of the SMS, MMS, E-mail, phone call, voice SMS, voice MMS, fax, voice mail and so on that are stored in the Sub-Menu of the mobile phone handset, fixed wireless phone and other wireless phone. A counter is provided to count the number of messages (viz. SMS, MMS and so on) that are sent, received and deleted in the mobile phone handset, fixed wireless phone and other wireless phone. Also another counter is provided to calculate the duration of messages that are sent, received in the mobile phone handset, fixed wireless phone and other wireless phone.

An electronic device comprising a code comparer and the said code comparer is connected to the CPU (Central Processing Unit and said code comparer is operated by CPU in the Mobile phone and said code comparer is operated with integrated chips within low power consumption obtained from the battery of the Mobile phone and the operation of low power consumption of Integrated Chips are operate continuously the function of said code comparer for a very long time and the operation of low power consumption of Integrated Chips to save the power consumption of said code comparer in the mobile phone. The code comparer compares the numbers and/or words of the received SMS, MMS, E-mail, phone call, voice SMS, voice MMS, fax, voice mail and so on sent by a sender, with the unwanted numbers and/or words of the SMS, MMS, E-mail, phone call, voice SMS, voice MMS, fax, voice mail and so on that are already stored in the memory device which are entered by the user.

The numbers can be a mobile phone number, telephone number, fixed wireless phone number and so on. The numbers can be mobile phone number, telephone number, fixed wireless phone number of SMS, MMS, phone call, voice SMS, voice MMS, fax, voice mail. The numbers and/or words can be Email ID. The numbers and/or words can be message of SMS, MMS, E-mail, phone call, voice SMS, voice MMS, fax, voice mail and so on. The numbers and/or words can be any keywords.

The power supply required to operate the device comprising a code comparer in the mobile phone handset, fixed wireless phone and other wireless phone which includes palm operating system based mobile phone, windows operating system based mobile smart phone is obtained from the battery of the mobile phone handset, fixed wireless phone and other wireless phone which includes palm operating system based mobile phone, windows operating system based mobile smart phone.

### 2. A) Means of Blocking the Unwanted SMS, MMS, Fax, E-Mail

At the time of incoming message viz. the numbers and/or words of the incoming SMS, MMS, Fax, E-mail is received in the mobile phone handset, fixed wireless phone and other wireless phone, the code comparer compares the numbers and/or words of the received SMS, MMS, Fax, E-mail with the list of unwanted numbers and/or words of the SMS, MMS, Fax, E-mail which is already stored in the memory device of mobile phone handset, fixed wireless phone and other wireless phone. If the numbers and/or words that is compared in the code comparer is same, then the numbers and/or words of the received SMS, MMS, Fax, E-mail is deleted in the receiving set. If the numbers and/or words compared in the code comparer differ, then the numbers and/or words of the received SMS, MMS, Fax, E-mail is indicated in the display screen of the receiving set. If the user activates the alert tone of the received SMS, MMS, Fax, E-mail, the tone will be heard by the user.

### 2. b) Means of Blocking the Unwanted Incoming Phone Calls

A user decides to avoid a certain incoming phone calls in the mobile phone handset, fixed wireless phone and other wireless phone. Consequently the user has no suitable facility in the mobile phone handset, fixed wireless phone and other wireless phone to block the incoming calls pertained to the numbers which the user wants to avoid. So in order to incorporate a suitable facility to block the unwanted incoming calls in the mobile phone handset, fixed wireless phone and other wireless phone of the user.

At the time of incoming phone call received in the mobile phone handset, fixed wireless phone and other wireless phone, the code comparer compares the number of the received incoming call with the list of unwanted numbers which is already stored in the memory device of mobile phone handset, fixed wireless phone and other wireless phone. If the numbers that is compared in the code comparer is same, then the number of the received incoming call is barred in the receiving set. If the numbers that is compared in the code comparer is different, then the number of the received incoming call is indicated in the display screen of the receiving set. If the user activates the alert tone of the received incoming call, the tone will be heard by the user.

### 2. c) Means of Blocking the Unwanted Voice Mail

A user decides to block a certain voice mail in the mobile phone handset, fixed wireless phone and other wireless phone. Consequently the user has no suitable facility in the mobile phone handset, fixed wireless phone and other wireless phone to block the voice mail pertained to the numbers and/or words which the user wants to avoid. So in order to incorporate a suitable facility to block the unwanted voice mail in the mobile phone handset, fixed wireless phone and other wireless phone of the user.

At the time of incoming voice mail which are received in the mobile phone handset, fixed wireless phone and other wireless phone, the code comparer compares the numbers and/or words of the received voice mail with the list of unwanted numbers and/or words which is already stored in the memory device of mobile phone handset, fixed wireless phone and other wireless phone. If the numbers and/or words that is compared in the code comparer is same, then the number and/or words of the received voice mail is deleted in the receiving set. If the numbers and/or words that is compared in the code comparer is different, then the received voice mail is indicated in the display screen of the receiving set. If the user activates the alert tone of the received voice mail, the tone will be heard by the user.

### 2. d) Means of Blocking the Unwanted Voice SMS

A user decides to block a certain voice SMS in the mobile phone handset, fixed wireless phone and other wireless phone. Consequently the user has no suitable facility in the mobile phone handset, fixed wireless phone and other wireless phone to block the voice SMS pertained to the numbers and/or words which the user wants to avoid. So in order to incorporate a suitable facility to block the unwanted voice SMS in the mobile phone handset, fixed wireless phone and other wireless phone of the user.

At the time of incoming voice SMS which are received in the mobile phone handset, fixed wireless phone and other wireless phone, the code comparer compares the numbers and/or words of the received voice SMS with the list of unwanted numbers and/or words which is already stored in the memory device of mobile phone handset, fixed wireless phone and other wireless phone. If the numbers and/or words that is compared in the code comparer is same, then the numbers and/or words of the received voice SMS is deleted in the receiving set. If the numbers and/or words that is compared in the code comparer is different, then the received voice SMS is indicated in the display screen of the receiving set. If the user activates the alert tone of the received voice SMS, the tone will be heard by the user.

### 2. e) Means of Blocking the Unwanted Voice MMS

A user decides to block a certain voice MMS in the mobile phone handset, fixed wireless phone and other wireless phone. Consequently the user has no suitable facility in the mobile phone handset, fixed wireless phone and other wireless phone to block the voice MMS pertained to the numbers and/or words which the user wants to avoid. So in order to incorporate a suitable facility to block the unwanted voice MMS in the mobile phone handset, fixed wireless phone and other wireless phone of the user.

At the time of incoming voice MMS which are received in the mobile phone handset, fixed wireless phone and other wireless phone, the code comparer compares the numbers and/or words of the received voice MMS with the list of unwanted numbers and/or words which is already stored in the memory device of mobile phone handset, fixed wireless phone and other wireless phone. If the numbers and/or words that is compared in the code comparer is same, then the numbers and/or words of the received voice MMS is deleted in the receiving set. If the numbers and/or words that is compared in the code comparer is different, then the received voice MMS is indicated in the display screen of the receiving set. If the user activates the alert tone of the received voice MMS, the tone will be heard by the user.

(II) This invention provides means of receiving the wanted SMS, MMS, E-mail, phone call, voice SMS, voice MMS, fax, voice mail and other mode of communication:
1) in the server database of SMS service center, MMS service center and other communication service center
2) in Mobile phone handset, Fixed wireless phone and other wireless phone.
   1. This invention provides means of receiving the wanted SMS, MMS, E-mail, phone call, voice SMS, voice MMS, fax, voice mail and other mode of communication in the server database of SMS service center, MMS service center and other communication service center
   1. a) Means of receiving the wanted SMS, MMS, E-mail, Fax

A mobile user can send the wanted numbers and/or words of the SMS, MMS, E-mail, fax using SMS or any other suitable settings from the mobile phone, fixed wireless phone and other wireless phone to the server database of SMS service center, MMS service center and other communication service center through the respective mobile service provider. A mobile user can send more than one wanted numbers and/or words of the SMS, MMS, E-mail, fax from the mobile phone, fixed wireless phone and other wireless phone to the server database of SMS service center, MMS service center and other communication service center. The wanted numbers and/or words of the SMS, MMS, E-mail, fax that are sent remain unchanged in the server database of SMS service center, MMS service center and other communication service center until the mobile user changes the already stored wanted numbers and/or words of the SMS, MMS, E-mail, fax. The SMS service center, MMS service center and other communication service center sends the wanted numbers and/or words of the SMS, MMS, E-mail, fax to the server database of the SMS, MMS and so on. Then the wanted numbers and/or words of the SMS, MMS, E-mail, fax are stored in the memory device of the respective server database.

The SMS, MMS, E-mail, fax message receiver receives the numbers and/or words of the incoming SMS, MMS, E-mail, fax sent by a sender. Sender means a person who sends the SMS, MMS, E-mail, fax to a known or an unknown person. Then the numbers and/or words of the incoming SMS, MMS, E-mail, fax are sent to the code comparer of the respective server database. The Code Comparer compares the numbers and/or words of the incoming SMS, MMS, E-mail, fax sent by a sender, with the wanted numbers and/or words of the SMS, MMS, E-mail, fax, that are already stored in the memory device, which are sent from the mobile phone, fixed wireless phone and other wireless phone by the mobile user. The wanted numbers and/or words of the SMS, MMS, E-mail, fax sent from the mobile phone, fixed wireless phone and other wireless phone by the mobile user are stored in the Code Comparer memory device.

The numbers can be a mobile phone number, telephone number, fixed wireless phone number and so on. The numbers can be mobile phone number, telephone number, fixed wireless phone number of SMS, MMS, phone call, fax. The numbers and/or words can be Email ID. The numbers and/or words can be message of SMS, MMS, E-mail, fax. The numbers and/or words can be any keywords.

An Electronic device comprising a code comparer and the said code comparer is connected to the CPU (Central Processing Unit) and said code comparer is operated by CPU in server database of SMS, MMS etc., and said code comparer is operated with integrated chips within low power consumption obtained from the battery and/or external power supply in the server database of SMS, MMS etc., and the operation of low power consumption of Integrated Chips are operate continuously the function of said code comparer for a very long time and the operation of low power consumption of Integrated Chips to save the power consumption of said code comparer in the server database of SMS, MMS etc.,. The power supply required to operate the device comprising a code compare in the server database of SMS service center, MMS service center and other communication service center which includes Serving GPRS Support Node (SGSN), Mobile Services Switching Center (MSC), E-mail, phone call, voice SMS, voice MMS, fax, voice mail is obtained from an external power supply. Said external power supply is a battery.

If the numbers and/or words that is compared in the code comparer are same, then the numbers and/or words of the incoming SMS, MMS, E-mail, fax is sent to the respective number, the message “Delivered to” is sent to the sender. If the numbers and/or words that is compared in the code comparer is different, then the numbers and/or words of the incoming SMS, MMS, E-mail, fax is blocked or deleted in the respective server database, the message “Not delivered to” is sent to the sender. The mobile user can remove the wanted numbers and/or words of the SMS, MMS, E-mail, fax that are already stored in the memory device of the server database of SMS service center, MMS service center and other communication service center, then the numbers and/or words of the incoming SMS, MMS, E-mail, fax that are received from the sender which is related to that removed wanted numbers and/or words of the SMS, MMS, E-mail, fax in the memory device of the server database of SMS service center, MMS service center and other communication service center can be sent to the mobile user. Every mobile user has the facility to receive the wanted numbers and/or words of the respective mobile service provider.

The server is integrated into the SMGMSC and code comparer. The server database is designed suitably to accept wanted numbers and/or words of the incoming SMS, MMS, E-mail, fax that are received from the sender. A device comprising a code comparer is designed suitably for comparing the numbers and/or words of the incoming SMS, MMS, E-mail, fax with the already stored wanted numbers and/or words of the SMS, MMS, E-mail, fax in the memory device of the server database of SMS service center, MMS service center and other communication service. The memory device is designed suitably for storing huge numbers and/or words.

Further if a mobile user wants to receive wanted numbers and/or words the person can also contact the customer care operator or the network operator and inform them of receiving the wanted numbers and/or words of SMS, MMS and other mode of communication.

In response to the contact and the information that are passed on to the network operator concerning receiving the wanted numbers and/or words of SMS, MMS and other mode of communication of the mobile user the network operator can directly enter the entries of the wanted numbers and/or words of SMS, MMS and so on to the server database of respective service center viz. the SMS service center, MMS service center and so on.

Also the network operator can enter more than one entry of the wanted numbers and/or words of SMS, MMS and so on to the respective server database.

In addition, the network operator can delete the wanted numbers and/or words of SMS, MMS and so on which have been already stored in the respective SMS server database, MMS server database and so on.

Further the numbers and/or words of the incoming SMS, MMS and so on which are accepted in the server database of respective service center can be sent to the mobile user. The wanted numbers and/or words can be removed from the stored entries of the respective server database by the instructions of the mobile user to the network operator. Based on the removal of the wanted numbers and/or words, the numbers and/or words of the incoming SMS, MMS and so on cannot be sent to the mobile user.

### 1. b) Means of Receiving the Wanted Voice Mail

Whenever a caller of any telecommunication instrument attempts to contact a person who has a mobile handset with a facility of voice mail box the code comparer compares the numbers and/or words of any telecommunication instrument of the call received with the wanted numbers and/or words that are stored by the user of the mobile phone handset in the memory device of the voice mail server database.

In the common use of the mobile phone handset there is no facility to store the wanted numbers and/or words specified by the user of mobile phone handset in the voice mail server database.

In order to incorporate this feature of receiving the wanted voice mail from any caller there is a dire need for implementing other arrangements to store the wanted numbers and/or words in the memory device of the voice mail server database as specified by the user of the mobile phone handset and also to compare the wanted numbers and/or words in the code comparer of the voice mail server database and to accept the voice mail message that is sent to the mobile user.

The numbers can be a mobile phone number, telephone number, fixed wireless phone number and so on. The numbers can be mobile phone number, telephone number, fixed wireless phone number of voice mail. The numbers and/or words can be message of SMS, phone call and so on. The numbers and/or words can be any keywords.

When a caller attempts the option of sending the message by a voice mail the numbers and/or words of the caller is being compared at that moment in the code comparer of the voice mail server database. If the numbers and/or words of the caller are found the same of the numbers and/or words specified and stored in the memory device of the voice mail server database by the mobile phone user, the message sent by the voice mail box is sent to the mobile user. The message by the voice mail of the caller becomes active ultimately. If the numbers and/or words of the caller are not found the same of the numbers and/or words specified and stored in the memory device of the voice mail server database by the mobile phone user, the message sent by the voice mail box is blocked. The message by the voice mail of the caller becomes dead ultimately.

### 1. c) Means for Receiving the Wanted Incoming Phone Calls

Whenever a caller of any telecommunication instrument attempts to contact a person the code comparer compares the numbers of any telecommunication instrument of the call received with the wanted numbers stored by the user of the mobile phone handset in the memory device of the respective server database.

In the common use of the mobile phone handset there is no facility to store the wanted numbers specified by the user of mobile phone handset in the respective server database.

To incorporate this feature of receiving the wanted incoming call from any caller there is a dire need for implementing other arrangements to store the wanted numbers in the memory device of the respective server database as specified by the user of the mobile phone handset and also to compare the wanted numbers in the code comparer of the respective server database and to accept the incoming call that is sent to the mobile user.

The numbers can be a mobile phone number, telephone number, fixed wireless phone number and so on. The numbers can be any keywords.

When a caller attempts the option of call the numbers of the caller is being compared at that moment in the code comparer of the respective server database. If the numbers of the caller is found the same of the numbers specified and stored in the memory device of the respective server database by the mobile phone user, the incoming call is sent to the mobile user. The incoming call of the caller becomes active ultimately. If the numbers of the caller is not found the same of the numbers specified and stored in the memory device of the respective server database by the mobile phone user, the incoming call is blocked. The incoming call of the caller becomes dead ultimately.

### 1. d) Means of Receiving the Wanted Voice SMS

Whenever a caller of any telecommunication instrument attempts to contact a person who has a mobile handset with a facility of voice SMS the code comparer compares the numbers and/or words of any telecommunication instrument of the call received with the wanted numbers and/or words that are stored by the user of the mobile phone handset in the memory device of the voice SMS server database.

In the common use of the mobile phone handset there is no facility to store the wanted numbers and/or words specified by the user of mobile phone handset in the voice SMS server database.

In order to incorporate this feature of receiving the wanted voice SMS from any caller there is a dire need for implementing other arrangements to store the wanted numbers and/or words in the memory device of the voice SMS server database as specified by the user of the mobile phone handset and also to compare the wanted numbers and/or words in the code comparer of the voice SMS server database and to accept the voice SMS that is sent to the mobile user.

The numbers can be a mobile phone number, telephone number, fixed wireless phone number and so on. The numbers can be mobile phone number, telephone number, fixed wireless phone number of voice SMS. The numbers and/or words can be message of SMS, phone call and so on. The numbers and/or words can be any keywords.

When a caller attempts the option of sending the message by a voice SMS the numbers and/or words of the caller is being compared at that moment in the code comparer of the voice SMS server database. If the numbers and/or words of the caller is found the same of the numbers and/or words specified and stored in the memory device of the voice SMS server database by the mobile phone user, the message sent by the voice SMS is sent to the mobile user. The message by the voice SMS of the caller becomes active ultimately. If the numbers and/or words of the caller is not found the same of the numbers and/or words specified and stored in the memory device of the voice SMS server database by the mobile phone user, the message sent by the voice SMS is blocked. The message by the voice SMS of the caller becomes dead ultimately.

### 1.e) Means of Receiving the Wanted Voice MMS

Whenever a caller of any telecommunication instrument attempts to contact a person who has a mobile handset with a facility of voice MMS the code comparer compares the numbers and/or words of any telecommunication instrument of the call received with the wanted numbers and/or words that are stored by the user of the mobile phone handset in the memory device of the voice MMS server database.

In the common use of the mobile phone handset there is no facility to store the wanted numbers and/or words specified by the user of mobile phone handset in the voice MMS server database.

In order to incorporate this feature of receiving the wanted voice MMS from any caller there is a dire need for implementing other arrangements to store the wanted numbers and/or words in the memory device of the voice MMS server database as specified by the user of the mobile phone handset and also to compare the wanted numbers and/or words in the code comparer of the voice MMS server database and to accept the voice MMS that is sent to the mobile user.

The numbers can be a mobile phone number, telephone number, fixed wireless phone number and so on. The numbers can be mobile phone number, telephone number, fixed wireless phone number of voice MMS. The numbers and/or words can be message of SMS, phone call and so on. The numbers and/or words can be any keywords.

When a caller attempts the option of sending the message by a voice MMS the numbers and/or words of the caller is being compared at that moment in the code comparer of the voice MMS server database. If the numbers and/or words of the caller is found the same of the numbers and/or words specified and stored in the memory device of the voice MMS server database by the mobile phone user, the message sent by the voice MMS is sent to the mobile user. The message by the voice MMS of the caller becomes active ultimately. If the numbers and/or words of the caller is not found the same of the numbers and/or words specified and stored in the memory device of the voice MMS server database by the mobile phone user, the message sent by the voice MMS is blocked. The message by the voice MMS of the caller becomes dead ultimately.

2. This invention provides means of receiving the wanted SMS, MMS, E-mail, phone call, voice SMS, voice MMS, fax, voice mail and other mode of communication in Mobile phone handset, Fixed wireless phone and other wireless phone.

The user stores wanted numbers and/or words of the SMS, MMS, E-mail, phone call, voice SMS, voice MMS, fax, voice mail and so on in the memory device of the mobile phone handset, fixed wireless phone and other wireless phone through the option—“Menu”.

In order to store the wanted numbers and/or words of the SMS, MMS, E-mail, phone call, voice SMS, voice MMS, fax, voice mail and so on, the user selects the Menu of the mobile phone handset, fixed wireless phone and other wireless phone, for example—Message Menu is opened by the user. The Message Menu has Sub-Menu—for example “Receive Wanted Numbers and/or Words”—viz. wanted numbers and/or words of the SMS, MMS, E-mail, phone call, voice SMS, voice MMS, fax, voice mail and so on. The user selects the option Sub-Menu and enters the wanted numbers and/or words of the SMS, MMS, E-mail, phone call, voice SMS, voice MMS, fax, voice mail and so on. The user can enter more than one wanted numbers and/or words of the SMS, MMS, E-mail, phone call, voice SMS, voice MMS, fax, voice mail and so on in the Sub-Menu. The wanted numbers and/or words of the SMS, MMS, E-mail, phone call, voice SMS, voice MMS, fax, voice mail and so on that are entered in the Sub-Menu are stored in the memory device of the mobile phone handset, fixed wireless phone and other wireless phone. The wanted numbers and/or words of the SMS, MMS, E-mail, phone call, voice SMS, voice MMS, fax, voice mail and so on that are stored remain unchanged in the Sub-Menu, until the user changes the wanted numbers and/or words of the SMS, MMS, E-mail, phone call, voice SMS, voice MMS, fax, voice mail and so on that are already stored in the Sub-Menu. The user can also remove the wanted numbers and/or words of the SMS, MMS, E-mail, phone call, voice SMS, voice MMS, fax, voice mail and so on that are already stored in the memory device of the mobile phone handset, fixed wireless phone and other wireless phone. A security code or lock code is provided to protect the wanted numbers and/or words of the SMS, MMS, E-mail, phone call, voice SMS, voice MMS, fax, voice mail and so on that are stored in the Sub-Menu of the mobile phone handset, fixed wireless phone and other wireless phone. A counter is provided to count the number of messages (viz. SMS, MMS and so on) that are sent, received and deleted in the mobile phone handset, fixed wireless phone and other wireless phone. Also another counter is provided to calculate the duration of messages that are sent, received in the mobile phone handset, fixed wireless phone and other wireless phone.

An Electronic device comprising a code comparer and the said code comparer is connected to the CPU (Central Processing Unit) and said code comparer is operated by CPU in the Mobile phone and said code comparer is operated with Integrated Chips within low power consumption obtained from the battery of the Mobile phone and the operation of low power consumption of Integrated Chips are operate continuously the function of said code comparer for a very long time and the operation of low power consumption of Integrated Chips to save the power consumption of said code comparer in the mobile phone. The code comparer compares the numbers and/or words of the received SMS, MMS, E-mail, phone call, voice SMS, voice MMS, fax, voice mail and so on sent by a sender, with the wanted numbers and/or words of the SMS, MMS, E-mail, phone call, voice SMS, voice MMS, fax, voice mail and so on that are already stored in the memory device which are entered by the user.

The numbers can be a mobile phone number, telephone number, fixed wireless phone number and so on. The numbers can be mobile phone number, telephone number, fixed wireless phone number of SMS, MMS, phone call, voice SMS, voice MMS, fax, voice mail. The numbers and/or words can be Email ID. The numbers and/or words can be message of SMS, MMS, E-mail, phone call, voice SMS, voice MMS, fax, voice mail and so on. The numbers and/or words can be any keywords.

The power supply required to operate the device comprising a code compare in the mobile phone handset, fixed wireless phone and other wireless phone which includes palm operating system based mobile phone, windows operating system based mobile smart phone is obtained from the battery of the mobile phone handset, fixed wireless phone and other wireless phone which includes palm operating system based mobile phone, windows operating system based mobile smart phone.

### 2.a) Means of Receiving the Wanted SMS, MMS, Fax, E-Mail

At the time of incoming message viz. the numbers and/or words of the incoming SMS, MMS, Fax, E-mail is received in the mobile phone handset, fixed wireless phone and other wireless phone, the code comparer compares the numbers and/or words of the received SMS, MMS, Fax, E-mail with the list of wanted numbers and/or words of the SMS, MMS, Fax, E-mail which is already stored in the memory device of mobile phone handset, fixed wireless phone and other wireless phone. If the numbers and/or words that is compared in the code comparer is same, then the numbers and/or words of the received SMS, MMS, Fax, E-mail is indicated in the display screen of the receiving set. If the user activates the alert tone of the received SMS, MMS, Fax, E-mail, the tone will be heard by the user. If the numbers and/or words that is compared in the code comparer is different, then the numbers and/or words of the received SMS, MMS, Fax, E-mail is deleted in the receiving set.

### 2.b) Means of Receiving the Wanted Incoming Phone Calls

A user decides to receive a certain incoming phone calls in the mobile phone handset, fixed wireless phone and other wireless phone. Consequently the user has no suitable facility in the mobile phone handset, fixed wireless phone and other wireless phone to receive the incoming calls pertained to the numbers which the user wants to accept. So in order to incorporate a suitable facility to receive the wanted incoming calls in the mobile phone handset, fixed wireless phone and other wireless phone of the user.

At the time of incoming phone call received in the mobile phone handset, fixed wireless phone and other wireless phone, the code comparer compares the number of the received incoming call with the list of wanted numbers which is already stored in the memory device of mobile phone handset, fixed wireless phone and other wireless phone. If the numbers that is compared in the code comparer is same, then the number of the received incoming call is indicated in the display screen of the receiving set. If the user activates the alert tone of the received incoming call, the tone will be heard by the user. If the numbers that is compared in the code comparer is different, then the number of the received incoming call is barred in the receiving set.

### 2.c) Means of Receiving the Wanted Voice Mail

A user decides to receive a certain voice mail in the mobile phone handset, fixed wireless phone and other wireless phone. Consequently the user has no suitable facility in the mobile phone handset, fixed wireless phone and other wireless phone to receive the voice mail pertained to the numbers and/or words which the user wants to accept. So in order to incorporate a suitable facility to receive the wanted voice mail in the mobile phone handset, fixed wireless phone and other wireless phone of the user.

At the time of incoming voice mail which are received in the mobile phone handset, fixed wireless phone and other wireless phone, the code comparer compares the numbers and/or words of the received voice mail with the list of wanted numbers and/or words which is already stored in the memory device of mobile phone handset, fixed wireless phone and other wireless phone. If the numbers and/or words that is compared in the code comparer is same, then the received voice mail is indicated in the display screen of the receiving set. If the user activates the alert tone of the received voice mail, the tone will be heard by the user. If the numbers and/or words that is compared in the code comparer is different, then the number of the received voice mail is deleted in the receiving set.

### 2.d) Means of Receiving the Wanted Voice SMS

A user decides to receive a certain voice SMS in the mobile phone handset, fixed wireless phone and other wireless phone. Consequently the user has no suitable facility in the mobile phone handset, fixed wireless phone and other wireless phone to receive the voice SMS pertained to the numbers and/or words which the user wants to accept. So in order to incorporate a suitable facility to receive the wanted voice SMS in the mobile phone handset, fixed wireless phone and other wireless phone of the user.

At the time of incoming voice SMS which are received in the mobile phone handset, fixed wireless phone and other wireless phone, the code comparer compares the numbers and/or words of the received voice SMS with the list of wanted numbers and/or words which is already stored in the memory device of mobile phone handset, fixed wireless phone and other wireless phone. If the numbers and/or words that is compared in the code comparer is same, then the received voice SMS is indicated in the display screen of the receiving set. If the user activates the alert tone of the received voice SMS, the tone will be heard by the user. If the numbers and/or words that is compared in the code comparer is different, then the number of the received voice SMS is deleted in the receiving set.

### 2.e) Means of Receiving the Wanted Voice MMS

A user decides to receive a certain voice MMS in the mobile phone handset, fixed wireless phone and other wireless phone. Consequently the user has no suitable facility in the mobile phone handset, fixed wireless phone and other wireless phone to receive the voice MMS pertained to the numbers and/or words which the user wants to accept. So in order to incorporate a suitable facility to receive the wanted voice MMS in the mobile phone handset, fixed wireless phone and other wireless phone of the user.

At the time of incoming voice MMS which are received in the mobile phone handset, fixed wireless phone and other wireless phone, the code comparer compares the numbers and/or words of the received voice MMS with the list of wanted numbers which is already stored in the memory device of mobile phone handset, fixed wireless phone and other wireless phone. If the numbers and/or words that is compared in the code comparer is same, then the received voice MMS is indicated in the display screen of the receiving set. If the user activates the alert tone of the received voice MMS, the tone will be heard by the user. If the numbers and/or words that is compared in the code comparer is different, then the number of the received voice MMS is deleted in the receiving set.

(III) This invention provides means of blocking the unwanted and receiving the wanted SMS, MMS, E-mail, phone call, voice SMS, voice MMS, fax, voice mail and other mode of communication
1) in the server database of SMS service center, MMS service center and other communication service center
2) in Mobile phone handset, Fixed wireless phone and other wireless phone

1. This invention provides means of blocking the unwanted and receiving the wanted SMS, MMS, E-mail, phone call, voice SMS, voice MMS, fax, voice mail and other mode of communication in the server database of SMS service center, MMS service center and other communication service center

### 1.a) Means of Blocking the Unwanted and Receiving the Wanted SMS, MMS, E-mail, Fax

A mobile user can send the unwanted and wanted numbers and/or words of the SMS, MMS, E-mail, fax using SMS or any other suitable settings from the mobile phone, fixed wireless phone and other wireless phone to the server database of SMS service center, MMS service center and other communication service center through the respective mobile service provider. A mobile user can send more than one unwanted and wanted numbers and/or words of the SMS, MMS, E-mail, fax from the mobile phone, fixed wireless phone and other wireless phone to the server database of SMS service center, MMS service center and other communication service center. The unwanted and wanted numbers and/or words of the SMS, MMS, E-mail, fax that are sent remain unchanged in the server database of SMS service center, MMS service center and other communication service center until the mobile user changes the already stored unwanted and wanted numbers and/or words of the SMS, MMS, E-mail, fax. The SMS service center, MMS service center and other communication service center sends the unwanted and wanted numbers and/or words of the SMS, MMS, E-mail, fax to the server database of the SMS, MMS and so on. Then the unwanted and wanted numbers and/or words of the SMS, MMS, E-mail, fax are stored in the memory device of the respective server database.

The SMS, MMS, E-mail, fax message receiver receives the numbers and/or words of the incoming SMS, MMS, E-mail, fax sent by a sender. Sender means a person who sends the SMS, MMS, E-mail, fax to a known or an unknown person. Then the numbers and/or words of the incoming SMS, MMS, E-mail, fax are sent to the code comparer of the respective server database. The Code Comparer compares the numbers and/or words of the incoming SMS, MMS, E-mail, fax sent by a sender, with the unwanted and wanted numbers and/or words of the SMS, MMS, E-mail, fax, that are already stored in the memory device, which are sent from the mobile phone, fixed wireless phone and other wireless phone by the mobile user. The unwanted and wanted numbers and/or words of the SMS, MMS, E-mail, fax sent from the mobile phone, fixed wireless phone and other wireless phone by the mobile user are stored in the Code Comparer memory device.

The numbers can be a mobile phone number, telephone number, fixed wireless phone number and so on. The numbers can be mobile phone number, telephone number, fixed wireless phone number of SMS, MMS, phone call, fax. The numbers and/or words can be Email ID. The numbers and/or words can be message of SMS, MMS, E-mail, fax. The numbers and/or words can be any keywords.

An Electronic device comprising a code comparer and the said code comparer is connected to the CPU (Central Processing Unit) and said code comparer is operated by CPU in server database of SMS,MMS etc., and said code comparer is operated with Integrated Chips within low power consumption obtained from the battery and/or external power supply in the server database of SMS,MMS etc., and the operation of low power consumption of Integrated Chips are operate continuously the function of said code comparer for a very long time and the operation of low power consumption of Integrated Chips to save the power consumption of said code comparer in the server database of SMS,MMS etc. The power supply required to operate the device comprising a code compare in the server database of SMS service center, MMS service center and other communication service center which includes Serving GPRS Support Node (SGSN), Mobile Services Switching Center (MSC), E-mail, phone call, voice SMS, voice MMS, fax, voice mail is obtained from an external power supply. Said external power supply is a battery.

A “New Option—Active and Deactive” is provided in the server database of SMS service center, MMS service center and other communication service center. “Active” means if the numbers and/or words of the incoming SMS, MMS and so on that are not found in the blocking database and also in the receiving database of the memory device, the numbers and/or words of the incoming SMS, MMS and so on are sent to the mobile user. “Deactive” means if the numbers and/or words of the incoming SMS, MMS and so on that are not found in the blocking database and also in the receiving database of the memory device, the numbers and/or words of the incoming SMS, MMS and so on are deleted in the respective server database.

The mobile user can send the selection of new option “Active or Deactive” by using SMS or any other suitable settings from the mobile phone, fixed wireless phone and other wireless phone to the server database of respective service center through the respective mobile service provider. The mobile user can also change the selected new option “Active or Deactive”. If the numbers and/or words of the incoming SMS, MMS and so on that are not found in the blocking database and also in the receiving database of the memory device and the mobile user has not selected the new option “Active or Deactive” in the server database of respective service center, then a New message (example: “Set the option Active or Deactive”) is sent to the mobile user from the server database of respective service center.

At the time of incoming numbers and/or words of the SMS, MMS, fax, E-mail which are received in the server database of respective service center, the numbers and/or words of the incoming SMS, MMS, E-mail, fax which is compared in the blocking database of the code comparer is different, then the numbers and/or words of the incoming SMS, MMS, E-mail, fax is sent to the respective number; if the numbers and/or words of the incoming SMS, MMS, E-mail, fax that is compared in the blocking database of code comparer is same; then the numbers and/or words of the incoming SMS, MMS, E-mail, fax that is compared in the receiving database of code comparer; if the numbers and/or words of the incoming SMS, MMS, E-mail, fax that is compared in the receiving database of code comparer is same; then the numbers and/or words of the incoming SMS, MMS, E-mail, fax is sent to the respective number; if the numbers and/or words of the incoming SMS, MMS, E-mail, fax that is compared in the receiving database of code comparer is different; then the numbers and/or words of the incoming SMS, MMS, E-mail, fax is operated based on the New option “Active or Deactive” as set in the respective server database. The mobile user can remove the unwanted and wanted numbers and/or words of the SMS, MMS, E-mail, fax that are already stored in the memory device of the server database of SMS service center, MMS service center and other communication service center, then the numbers and/or words of the incoming SMS, MMS, E-mail, fax that are received from the sender which is related to that removed unwanted and wanted numbers and/or words of the SMS, MMS, E-mail, fax in the memory device of the server database of SMS service center, MMS service center and other communication service center can be sent to the mobile user. Every mobile user has the facility to blocking the unwanted and receiving the wanted numbers and/or words of the respective mobile service provider.

The server is integrated into the SMGMSC and Code Comparer. The server database is designed suitably to delete unwanted and accept wanted numbers and/or words of the incoming SMS, MMS, E-mail, fax that are received from the sender. A device comprising a Code Comparer is designed suitably for comparing the numbers and/or words of the incoming SMS, MMS, E-mail, fax with the already stored unwanted and wanted numbers and/or words of the SMS, MMS, E-mail, fax in the memory device of the server database of SMS service center, MMS service center and other communication service. The memory device is designed suitably for storing huge numbers and/or words.

Further if a mobile user wants to block the unwanted and receive the wanted numbers and/or words, and selects the new option “Active or Deactive” the person can also contact the customer care operator or the network operator and inform them of blocking the unwanted and receiving the wanted numbers and/or words of SMS, MMS and other mode of communication and also can inform the operator the selection of the new option “Active or Deactive.”

In response to the contact and the information that are passed on to the network operator concerning blocking the unwanted and receiving the wanted numbers and/or words of SMS, MMS and other mode of communication of the mobile user the network operator can directly enter the entries of the unwanted and wanted numbers and/or words of SMS, MMS and so on to the server database of respective service center viz. the SMS service center, MMS service center and so on. The network operator can also set the new option “Active or Deactive” in the server database of the respective service center.

Also the network operator can enter more than one entry of the unwanted and wanted numbers and/or words of SMS, MMS and so on to the respective server database.

In addition, the network operator can delete the unwanted and wanted numbers and/or words of SMS, MMS and so on which have been already stored in the respective SMS server database, MMS server database and so on. The network operator can also changes the already selection of the new option “Active or Deactive.”

Further the numbers and/or words of the incoming SMS, MMS and so on which are blocked in the server database of respective service center cannot be sent to the mobile user and the numbers and/or words of the incoming SMS, MMS and so on which are accepted in the server database of respective service center can be sent to the mobile user. The unwanted and wanted numbers and/or words can be removed from the stored entries of the respective server database by the instructions of the mobile user to the network operator.

### 1.b) Means of Blocking the Unwanted and Receiving the Wanted Voice Mail

Whenever a caller of any telecommunication instrument attempts to contact a person who has a mobile handset with a facility of voice mail box the code comparer compares the numbers and/or words of any telecommunication instrument of the call received with the unwanted and wanted numbers and/or words that are stored by the user of the mobile phone handset in the memory device of the voice mail server database.

In the common use of the mobile phone handset there is no facility to store the unwanted and wanted numbers and/or words specified by the user of mobile phone handset in the voice mail server database.

In order to incorporate this feature of blocking the unwanted and receiving the wanted voice mail from any caller there is a dire need for implementing other arrangements to store the unwanted and wanted numbers and/or words in the memory device of the voice mail server database as specified by the user of the mobile phone handset and also to compare the unwanted and wanted numbers and/or words in the code comparer of the voice mail server database and to block the voice mail message that is sent to the mobile user and also to accept the voice mail message that is sent to the mobile user.

The numbers can be a mobile phone number, telephone number, fixed wireless phone number and so on. The numbers can be mobile phone number, telephone number, fixed wireless phone number of voice mail. The numbers and/or words can be message of SMS, phone call and so on. The numbers and/or words can be any keywords.

When a caller attempts the option of sending the message by a voice mail the numbers and/or words of the caller is being compared at that moment in the code comparer of the voice mail server database. If the numbers and/or words of the caller is not found the same in the blocking database of the numbers and/or words specified and stored in the memory device of the voice mail server database by the mobile phone user, the message sent by the voice mail box is sent to the mobile user. The message by the voice mail of the caller becomes active ultimately. If the numbers and/or words of the caller is found the same in the blocking database of the numbers and/or words specified and stored in the memory device of the voice mail server database by the mobile phone user, then the numbers and/or words of the caller is compared in the receiving database of the numbers and/or words specified and stored in the memory device of the voice mail server database by the mobile phone user. If the numbers and/or words of the caller is found the same in the receiving database of the numbers and/or words specified and stored in the memory device of the voice mail server database by the mobile phone user, the message sent by the voice mail box is sent to the mobile user. The message by the voice mail of the caller becomes active ultimately. If the numbers and/or words of the caller is not found the same in the receiving database of the numbers and/or words specified and stored in the memory device of the voice mail server database by the mobile phone user, then the numbers and/or words of the caller is operated based on the New option “Active or Deactive” as set in the server database. “Active” means the message sent by the voice mail box is sent to the mobile user. The message by the voice mail of the caller becomes active ultimately. “Deactive” means the message sent by the voice mail box is blocked. The message by the voice mail of the caller becomes dead ultimately.

### 1. c) Means of Blocking the Unwanted and Receiving the Wanted Incoming Phone Calls

Whenever a caller of any telecommunication instrument attempts to contact a person the code comparer compares the numbers of any telecommunication instrument of the call received with the unwanted and wanted numbers that are stored by the user of the mobile phone handset in the memory device of the respective server database.

In the common use of the mobile phone handset there is no facility to store the unwanted and wanted numbers specified by the user of mobile phone handset in the respective server database.

In order to incorporate this feature of blocking the unwanted and receiving the wanted incoming call from any caller there is a dire need for implementing other arrangements to store the unwanted and wanted numbers in the memory device of the respective server database as specified by the user of the mobile phone handset and also to compare the unwanted and wanted numbers in the code comparer of the respective server database and to block the incoming call that is sent to the mobile user and also to accept the incoming call that is sent to the mobile user.

The numbers can be a mobile phone number, telephone number, fixed wireless phone number and so on. The numbers can be any keywords.

When a caller attempts the option of call the numbers of the caller is being compared at that moment in the code comparer of the respective server database. If the numbers of the caller is not found the same in the blocking database of the numbers specified and stored in the memory device of the respective server database by the mobile phone user, the incoming call is sent to the mobile user. The incoming call of the caller becomes active ultimately. If the numbers of the caller is found the same in the blocking database of the numbers specified and stored in the memory device of the respective server database by the mobile phone user, then the numbers of the caller is compared in the receiving database of the numbers specified and stored in the memory device of the respective server database by the mobile phone user. If the numbers of the caller is found the same in the receiving database of the numbers specified and stored in the memory device of the respective server database by the mobile phone user, the incoming call is sent to the mobile user. The incoming call of the caller becomes active ultimately. If the numbers of the caller is not found the same in the receiving database of the numbers specified and stored in the memory device of the respective server database by the mobile phone user, then the numbers of the caller is operated based on the New option “Active or Deactive” as set in the server database. “Active” means the incoming call is sent to the mobile user. The incoming call of the caller becomes active ultimately. “Deactive” means the incoming call is blocked. The incoming call of the caller becomes dead ultimately.

### 1.d) Means of Blocking the Unwanted and Receiving the Wanted Voice SMS

Whenever a caller of any telecommunication instrument attempts to contact a person who has a mobile handset with a facility of voice SMS the code comparer compares the numbers and/or words of any telecommunication instrument of the call received with the unwanted and wanted numbers and/or words that are stored by the user of the mobile phone handset in the memory device of the voice SMS server database.

In the common use of the mobile phone handset there is no facility to store the unwanted and wanted numbers and/or words specified by the user of mobile phone handset in the voice SMS server database.

In order to incorporate this feature of blocking the unwanted and receiving the wanted voice SMS from any caller there is a dire need for implementing other arrangements to store the unwanted and wanted numbers and/or words in the memory device of the voice SMS server database as specified by the user of the mobile phone handset and also to compare the unwanted and wanted numbers and/or words in the code comparer of the voice SMS server database and to block the voice SMS that is sent to the mobile user and also to accept the voice SMS that is sent to the mobile user.

The numbers can be a mobile phone number, telephone number, fixed wireless phone number and so on. The numbers can be mobile phone number, telephone number, fixed wireless phone number of voice SMS. The numbers and/or words can be message of SMS, phone call and so on. The numbers and/or words can be any keywords.

When a caller attempts the option of sending the message by a voice SMS the numbers and/or words of the caller is being compared at that moment in the code comparer of the voice SMS server database. If the numbers and/or words of the caller is not found the same in the blocking database of the numbers and/or words specified and stored in the memory device of the voice SMS server database by the mobile phone user, the message sent by the voice SMS is sent to the mobile user. The message by the voice SMS of the caller becomes active ultimately. If the numbers and/or words of the caller is found the same in the blocking database of the numbers and/or words specified and stored in the memory device of the voice SMS server database by the mobile phone user, then the numbers and/or words of the caller is compared in the receiving database of the numbers and/or words specified and stored in the memory device of the voice SMS server database by the mobile phone user. If the numbers and/or words of the caller is found the same in the receiving database of the numbers and/or words specified and stored in the memory device of the voice SMS server database by the mobile phone user, the message sent by the voice SMS is sent to the mobile user. The message by the voice SMS of the caller becomes active ultimately. If the numbers and/or words of the caller is not found the same in the receiving database of the numbers and/or words specified and stored in the memory device of the voice SMS server database by the mobile phone user, then the numbers and/or words of the caller is operated based on the New option “Active or Deactive” as set in the server database. “Active” means the message sent by the voice SMS is sent to the mobile user. The message by the voice SMS of the caller becomes active ultimately. “Deactive” means the message sent by the voice SMS is blocked. The message by the voice SMS of the caller becomes dead ultimately.

### 1.e) Means of Blocking the Unwanted and Receiving the Wanted Voice MMS

Whenever a caller of any telecommunication instrument attempts to contact a person who has a mobile handset with a facility of voice MMS the code comparer compares the numbers and/or words of any telecommunication instrument of the call received with the unwanted and wanted numbers and/or words that are stored by the user of the mobile phone handset in the memory device of the voice MMS server database.

In the common use of the mobile phone handset there is no facility to store the unwanted and wanted numbers and/or words specified by the user of mobile phone handset in the voice MMS server database.

In order to incorporate this feature of blocking the unwanted and receiving the wanted voice MMS from any caller there is a dire need for implementing other arrangements to store the unwanted and wanted numbers and/or words in the memory device of the voice MMS server database as specified by the user of the mobile phone handset and also to compare the unwanted and wanted numbers and/or words in the code comparer of the voice MMS server database and to block the voice MMS that is sent to the mobile user and also to accept the voice MMS that is sent to the mobile user.

The numbers can be a mobile phone number, telephone number, fixed wireless phone number and so on. The numbers can be mobile phone number, telephone number, fixed wireless phone number of voice MMS. The numbers and/or words can be message of SMS, phone call and so on. The numbers and/or words can be any keywords.

When a caller attempts the option of sending the message by a voice MMS the numbers and/or words of the caller is being compared at that moment in the code comparer of the voice MMS server database. If the numbers and/or words of the caller is not found the same in the blocking database of the numbers and/or words specified and stored in the memory device of the voice MMS server database by the mobile phone user, the message sent by the voice MMS is sent to the mobile user. The message by the voice MMS of the caller becomes active ultimately. If the numbers and/or words of the caller is found the same in the blocking database of the numbers and/or words specified and stored in the memory device of the voice MMS server database by the mobile phone user, then the numbers and/or words of the caller is compared in the receiving database of the numbers and/or words specified and stored in the memory device of the voice MMS server database by the mobile phone user. If the numbers and/or words of the caller is found the same in the receiving database of the numbers and/or words specified and stored in the memory device of the voice MMS server database by the mobile phone user, the message sent by the voice MMS is sent to the mobile user. The message by the voice MMS of the caller becomes active ultimately. If the numbers and/or words of the caller is not found the same in the receiving database of the numbers and/or words specified and stored in the memory device of the voice MMS server database by the mobile phone user, then the numbers and/or words of the caller is operated based on the New option “Active or Deactive” as set in the server database. “Active” means the message sent by the voice MMS is sent to the mobile user. The message by the voice MMS of the caller becomes active ultimately. “Deactive” means the message sent by the voice MMS is blocked. The message by the voice MMS of the caller becomes dead ultimately.

2. This invention provides means of blocking the unwanted and receiving the wanted SMS, MMS, E-mail, phone call, voice SMS, voice MMS, fax, voice mail and other mode of communication in Mobile phone handset, Fixed wireless phone and other wireless phone.

The user stores unwanted and wanted numbers and/or words of the SMS, MMS, E-mail, phone call, voice SMS, voice MMS, fax, voice mail and so on in the memory device of the mobile phone handset, fixed wireless phone and other wireless phone through the option—“Menu”.

In order to store an unwanted and wanted numbers and/or words of the SMS, MMS, E-mail, phone call, voice SMS, voice MMS, fax, voice mail and so on, the user selects the Menu of the mobile phone handset, fixed wireless phone and other wireless phone, for example—Message Menu is opened by the user. The Message Menu has Sub-Menu—for example “Block Unwanted Numbers and/or Words”—viz. unwanted numbers and/or words of the SMS, MMS, E-mail, phone call, voice SMS, voice MMS, fax, voice mail and so on, “Receive Wanted Numbers and/or Words”—viz. wanted numbers and/or words of the SMS, MMS, E-mail, phone call, voice SMS, voice MMS, fax, voice mail and so on and a “New message option—Active and Deactive” is provided in the Sub-Menu. “Active” means if the numbers and/or words of the received SMS, MMS, E-mail, phone call, voice SMS, voice MMS, fax, voice mail and so on that are not found in the blocking database and also in the receiving database of the memory device, then the numbers and/or words of the incoming SMS, MMS, E-mail, phone call, voice SMS, voice MMS, fax, voice mail and so on is indicated in the display screen of the receiving set. “Deactive” means if the numbers and/or words of the received SMS, MMS, E-mail, phone call, voice SMS, voice MMS, fax, voice mail and so on that are not found in the blocking database and also in the receiving database of the memory device, then the numbers and/or words of the incoming SMS, MMS, E-mail, phone call, voice SMS, voice MMS, fax, voice mail and so on is deleted in the receiving set. The user selects the option Sub-Menu and enters the unwanted and wanted numbers and/or words of the SMS, MMS, E-mail, phone call, voice SMS, voice MMS, fax, voice mail and so on. If the user enters the same numbers and/or words of the SMS, MMS, E-mail, phone call, voice SMS, voice MMS, fax, voice mail and so on in the Blocking database and also in the Receiving database in the Sub-Menu, then a message example: “Error number” is indicated on the display screen of the receiving set. The user can enter more than one unwanted and wanted numbers and/or words of the SMS, MMS, E-mail, phone call, voice SMS, voice MMS, fax, voice mail and so on in the Sub-Menu. The unwanted and wanted numbers and/or words of the SMS, MMS, E-mail, phone call, voice SMS, voice MMS, fax, voice mail and so on that are entered in the Sub-Menu are stored in the memory device of the mobile phone handset, fixed wireless phone and other wireless phone. The unwanted and wanted numbers and/or words of the SMS, MMS, E-mail, phone call, voice SMS, voice MMS, fax, voice mail and so on that are stored remain unchanged in the blocking database and receiving database of the Sub-Menu, until the user changes the unwanted and wanted numbers and/or words of the SMS, MMS, E-mail, phone call, voice SMS, voice MMS, fax, voice mail and so on that are already stored in the Sub-Menu. The user can also change the selection of the new option “Active or Deactive” in the Sub-Menu. The user can also remove the unwanted and wanted numbers and/or words of the SMS, MMS, E-mail, phone call, voice SMS, voice MMS, fax, voice mail and so on that are already stored in the memory device of the mobile phone handset, fixed wireless phone and other wireless phone. A security code or lock code is provided to protect the unwanted and wanted numbers and/or words of the SMS, MMS, E-mail, phone call, voice SMS, voice MMS, fax, voice mail and so on that are stored in the Sub-Menu of the mobile phone handset, fixed wireless phone and other wireless phone. A counter is provided to count the number of messages (viz. SMS, MMS and so on) that are sent, received and deleted in the mobile phone handset, fixed wireless phone and other wireless phone. Also another counter is provided to calculate the duration of messages that are sent, received in the mobile phone handset, fixed wireless phone and other wireless phone.

An Electronic device comprising a code comparer and the said code comparer is connected to the CPU (Central Processing Unit) and said code comparer is operated by CPU in the Mobile phone and said code comparer is operated with Integrated Chips within low power consumption obtained from the battery of the Mobile phone and the operation of low power consumption of Integrated Chips are operate continuously the function of said code comparer for a very long time and the operation of low power consumption of Integrated Chips to save the power consumption of said code comparer in the mobile phone. The code comparer compares the numbers and/or words of the received SMS, MMS, E-mail, phone call, voice SMS, voice MMS, fax, voice mail and so on sent by a sender, with the unwanted and wanted numbers and/or words of the SMS, MMS, E-mail, phone call, voice SMS, voice MMS, fax, voice mail and so on that are already stored in the memory device which are entered by the user.

The numbers can be a mobile phone number, telephone number, fixed wireless phone number and so on. The numbers can be mobile phone number, telephone number, fixed wireless phone number of SMS, MMS, phone call, voice SMS, voice MMS, fax, voice mail. The numbers and/or words can be Email ID. The numbers and/or words can be message of SMS, MMS, E-mail, phone call, voice SMS, voice MMS, fax, voice mail and so on. The numbers and/or words can be any keywords.

The power supply required to operate the device comprising a code compare in the mobile phone handset, fixed wireless phone and other wireless phone which includes palm operating system based mobile phone, windows operating system based mobile smart phone is obtained from the battery of the mobile phone handset, fixed wireless phone and other wireless phone which includes palm operating system based mobile phone, windows operating system based mobile smart phone.

If the numbers and/or words of the received SMS, MMS, E-mail, phone call, voice SMS, voice MMS, fax, voice mail and so on that are not found in the blocking database and also in the receiving database of the memory device, also the user has not set the new option “Active or Deactive” in the Sub-Menu, then a New message (example: “Set the option Active or Deactive”) is indicated on the display screen of the receiving set.

### 2. A) Means of Blocking the Unwanted and Receiving the Wanted SMS, MMS, Fax, E-mail

At the time of incoming message viz. the numbers and/or words of the incoming SMS, MMS, Fax, E-mail is received in the mobile phone handset, fixed wireless phone and other wireless phone, the code comparer compares the numbers and/or words of the received SMS, MMS, Fax, E-mail with the list of unwanted and wanted numbers and/or words of the SMS, MMS, Fax, E-mail which is already stored in the memory device of mobile phone handset, fixed wireless phone and other wireless phone. If the numbers and/or words that is compared in the blocking database of the code comparer is different, then the numbers and/or words of the received SMS, MMS, Fax, E-mail is indicated in the display screen of the receiving set. If the user activates the alert tone of the received SMS, MMS, Fax, E-mail, the tone will be heard by the user. If the numbers and/or words compared in the blocking database of the code comparer is same, then the numbers and/or words that is compared in the receiving database of the code comparer. If the numbers and/or words that is compared in the receiving database of the code comparer is same, then the numbers and/or words of the received SMS, MMS, Fax, E-mail is indicated in the display screen of the receiving set. If the user activates the alert tone of the received SMS, MMS, Fax, E-mail, the tone will be heard by the user. If the numbers and/or words that is compared in the receiving database of the code comparer is different, then the numbers and/or words of the received SMS, MMS, Fax, E-mail is operated based on the New message option “Active or Deactive” as selected in the Sub-Menu. “Active” means the numbers and/or words of the received SMS, MMS, E-mail, fax is indicated in the display screen of the receiving set. “Deactive” means the numbers and/or words of the received SMS, MMS, E-mail, fax is deleted in the receiving set.

### 2. b) Means of Blocking the Unwanted and Receiving the Wanted Incoming Phone Calls

A user decides to block and also to receive a certain incoming phone calls in the mobile phone handset, fixed wireless phone and other wireless phone. Consequently the user has no suitable facility in the mobile phone handset, fixed wireless phone and other wireless phone to block the incoming calls pertained to the numbers which the user wants to avoid and also to receive the incoming calls pertained to the numbers which the user wants to accept. So in order to incorporate a suitable facility to block the unwanted and receive the wanted incoming calls in the mobile phone handset, fixed wireless phone and other wireless phone of the user:

At the time of incoming phone call which are received in the mobile phone handset, fixed wireless phone and other wireless phone, the code comparer compares the number of the received incoming call with the list of unwanted and wanted numbers which is already stored in the memory device of mobile phone handset, fixed wireless phone and other wireless phone. If the number that is compared in the blocking database of the code comparer is different, then the number of the received incoming call is indicated in the display screen of the receiving set. If the user activates the alert tone of the received incoming call, the tone will be heard by the user. If the number that is compared in the blocking database of the code comparer is same, then the number that is compared in the receiving database of the code comparer. If the number that is compared in the receiving database of the code comparer is same, then the number of the received incoming call is indicated in the display screen of the receiving set. If the user activates the alert tone of the received incoming call, the tone will be heard by the user. If the number that is compared in the receiving database of the code comparer is different, then the number of the received incoming call is operated based on the New message option “Active or Deactive” as selected in the Sub-Menu. “Active” means the number of the received incoming call is indicated in the display screen of the receiving set. “Deactive” means the number of the received incoming call is deleted in the receiving set.

### 2. c) Means of Blocking the Unwanted and Receiving the Wanted Voice Mail

A user decides to block and also to receive a certain voice mail in the mobile phone handset, fixed wireless phone and other wireless phone. Consequently the user has no suitable facility in the mobile phone handset, fixed wireless phone and other wireless phone to block the voice mail pertained to the numbers and/or words which the user wants to avoid and also to receive the voice mail pertained to the numbers and/or words which the user wants to accept. So in order to incorporate a suitable facility to block the unwanted and receive the wanted voice mail in the mobile phone handset, fixed wireless phone and other wireless phone of the user:

At the time of incoming voice mail which are received in the mobile phone handset, fixed wireless phone and other wireless phone, the code comparer compares the numbers and/or words of the received voice mail with the list of unwanted and wanted numbers and/or words which is already stored in the memory device of mobile phone handset, fixed wireless phone and other wireless phone. If the numbers and/or words that is compared in the blocking database of the code comparer is different, then the numbers and/or words of the received voice mail is indicated in the display screen of the receiving set. If the user activates the alert tone of the received voice mail, the tone will be heard by the user. If the numbers and/or words that is compared in the blocking database of the code comparer is same, then the numbers and/or words that is compared in the receiving database of the code comparer. If the numbers and/or words that is compared in the receiving database of the code comparer is same, then the numbers and/or words of the received voice mail is indicated in the display screen of the receiving set. If the user activates the alert tone of the received voice mail, the tone will be heard by the user. If the numbers and/or words that is compared in the receiving database of the code comparer is different, then the numbers and/or words of the received voice mail is operated based on the New message option “Active or Deactive” as selected in the Sub-Menu. “Active” means the numbers and/or words of the received voice mail is indicated in the display screen of the receiving set. “Deactive” means the numbers and/or words of the received voice mail is deleted in the receiving set.

### 2.d) Means of Blocking the Unwanted and Receiving the Wanted Voice SMS

A user decides to block and also to receive a certain voice SMS in the mobile phone handset, fixed wireless phone and other wireless phone. Consequently the user has no suitable facility in the mobile phone handset, fixed wireless phone and other wireless phone to block the voice SMS pertained to the numbers and/or words which the user wants to avoid to and also to receive the voice SMS pertained to the numbers and/or words which the user wants to accept. So in order to incorporate a suitable facility to block the unwanted and receive the wanted voice SMS in the mobile phone handset, fixed wireless phone and other wireless phone of the user:

At the time of incoming voice SMS which are received in the mobile phone handset, fixed wireless phone and other wireless phone, the code comparer compares the numbers and/or words of the received voice SMS with the list of unwanted and wanted numbers and/or words which is already stored in the memory device of mobile phone handset, fixed wireless phone and other wireless phone. If the numbers and/or words that is compared in the blocking database of the code comparer is different, then the numbers and/or words of the received voice SMS is indicated in the display screen of the receiving set. If the user activates the alert tone of the received voice SMS, the tone will be heard by the user. If the numbers and/or words that is compared in the blocking database of the code comparer is same, then the numbers and/or words that is compared in the receiving database of the code comparer. If the numbers and/or words that is compared in the receiving database of the code comparer is same, then the numbers and/or words of the received voice SMS is indicated in the display screen of the receiving set. If the user activates the alert tone of the received voice SMS, the tone will be heard by the user. If the numbers and/or words that is compared in the receiving database of the code comparer is different, then the numbers and/or words of the received voice SMS is operated based on the New message option “Active or Deactive” as selected in the Sub-Menu. “Active” means the numbers and/or words of the received voice SMS is indicated in the display screen of the receiving set. “Deactive” means the numbers and/or words of the received voice SMS is deleted in the receiving set.

### 2. e) Means of Blocking the Unwanted and Receiving the Wanted Voice MMS

A user decides to block and also to receive a certain voice MMS in the mobile phone handset, fixed wireless phone and other wireless phone. Consequently the user has no suitable facility in the mobile phone handset, fixed wireless phone and other wireless phone to block the voice MMS pertained to the numbers and/or words which the user wants to avoid and also to receive the voice MMS pertained to the numbers and/or words which the user wants to accept. So in order to incorporate a suitable facility to block the unwanted and receive the wanted voice MMS in the mobile phone handset, fixed wireless phone and other wireless phone of the user:

At the time of incoming voice MMS which are received in the mobile phone handset, fixed wireless phone and other wireless phone, the code comparer compares the numbers and/or words of the received voice MMS with the list of unwanted and wanted numbers and/or words which is already stored in the memory device of mobile phone handset, fixed wireless phone and other wireless phone. If the numbers and/or words compared in the blocking database of the code comparer is different, then the numbers and/or words of the received voice MMS is indicated in the display screen of the receiving set. If the user activates the alert tone of the received voice MMS, the tone will be heard by the user. If the numbers and/or words compared in the blocking database of the code comparer are the same, then the numbers and/or words are compared in the receiving database of the code comparer. If the numbers and/or words that are compared in the receiving database of the code comparer is same, then the numbers and/or words of the received voice MMS is indicated in the display screen of the receiving set. If the user activates the alert tone of the received voice MMS, the tone will be heard by the user. If the numbers and/or words that is compared in the receiving database of the code comparer is different, then the numbers and/or words of the received voice MMS is operated based on the New message option “Active or Deactive” as selected in the Sub-Menu. “Active” means the number of the received voice MMS is indicated in the display screen of the receiving set. “Deactive” means the number of the received voice MMS is deleted in the receiving set.

I claim:

1. An electronic device comprising:
a code comparer connected to a central processing unit and operated with integrated chips with low power consumption in a server database of a communication service center or in a mobile phone, the code comparer for use in blocking an unwanted or for receiving a wanted communication or blocking an unwanted and receiving a wanted communication directed to the mobile phone by comparing one or more numbers and/or words of the incoming communication with stored numbers and/or words of the communication in a memory device of the server database of the communication service center or of the mobile phone.

2. The electronic device of claim 1, wherein the code comparer comprises four bridge circuits configured for use in a four bit code system, which can represent up to 16 different characters.

3. The electronic device of claim 1, wherein the code comparer comprises six bridge circuits configured for use in a six bit code system, which can represent up to 64 different characters.

4. The electronic device of claim 1, wherein the code comparer is configured to compare the said characters which may be represented by numbers and/or words in a four bit binary code or six bit binary code or more binary code.

5. The electronic device of claim 1, the code comparer comprises a plurality of transistors, diodes, resistors configured to operate within low power consumption obtained from a battery and/or an external power supply in the server database of the communication service center, or a battery of the mobile phone.

6. The electronic device of claim 1, wherein the code comparer is configured to be operated with integrated chips within low power consumption obtained from a battery and/or external power supply in the server database of the communication service center, or a battery of the mobile phone.

7. The electronic device of claim 2, wherein the bridge circuits are configured to be operated by a switching circuit by switching off certain of the bridge circuits of a total plurality of bridge circuits of the code comparer by the given input of characters, wherein said operation is adapted to save the power consumption of said code comparer in the server database of the communication service center or in the mobile phone.

8. The electronic device of claim 1, wherein transistors, diodes, and resistors of the code comparer are configured to be operated by a switching circuit by switching off certain of the plurality of transistors, diodes, resistors of a total plurality of transistors, diodes, resistors of the code comparer by the given input of characters, wherein said operation is adapted to save the power consumption of said code comparer in the server database of the communication service center or in the mobile phone.

9. The electronic device of claim 1, wherein the code comparer is connected to and operated by the CPU in the server database of the communication service center.

10. The electronic device of claim 1, wherein the code comparer is connected to and operated by the CPU in the mobile phone.

11. The electronic device of claim 1, wherein the functions of the code comparer are implemented in the cloud service or cloud computing.

12. An electronic device comprising a code comparer, wherein the said code comparer is connected to a Central Processing Unit and said code comparer is operated by the CPU in a server database of SMS or MMS, and also in a mobile phone and said code comparer is operated with integrated chips with low power consumption obtained from a battery and/or external power supply in the server database of SMS or MMS, and also from a battery of the mobile phone and the operation of low power consumption of integrated chips are operate continuously the function of said code comparer and the operation of low power consumption of integrated chips to save the power consumption of said code comparer in the server database of SMS or MMS, and also in the mobile phone and the said code comparer for use in blocking the unwanted, for use in receiving the wanted, for use in blocking the unwanted and receiving the wanted SMS, MMS, E-mail, phone calls, voice SMS, voice MMS, fax, voice mail and other modes of communication, including cell mail or mobile mail sent by mobile phone, fixed wireless phone and other communication devices which includes a Personal Digital Assistant, computer which are being processed by the code comparer by comparing the numbers and/or words of the incoming SMS, MMS, E-mail, phone call, voice SMS, voice MMS, fax, voice mail and other modes of communication which includes cell mail, mobile mail with the already stored numbers and/or words of the SMS, MMS, E-mail, phone call, voice SMS, voice MMS, fax, voice mail and other communication includes cell mail, mobile mail in the memory device of the server database of SMS service center, MMS service center and other communication service center which includes Serving GPRS Support Node (SGSN), Mobile Services Switching Center (MSC), E-mail, phone call, voice SMS, voice MMS, fax, voice mail and including the memory device of the mobile phone handset, fixed wireless phone and other wireless phones which include palm operating system based mobile phone, windows operating system based mobile smart phone.

13. An electronic device comprising a code comparer as claimed in claim 12, wherein the numbers are selected from the group consisting of: telephone numbers, fixed wireless phone numbers, mobile phone numbers, fixed wireless phone numbers of SMS, MMS, phone call, voice SMS, voice MMS, fax, voice mail, Email IDs, messages of SMS, MMS, E-mail, phone calls, voice SMS, voice MMS, fax, voice mail and other communications which includes cell mail, and mobile mail.

14. An electronic device comprising a code comparer as claimed in claim 12, wherein, the power supply required to operate the said device in the server database of SMS service center, MMS service center and other communication service center includes Serving GPRS Support Node (SGSN), Mobile Services Switching Center (MSC), E-mail, phone call, voice SMS, voice MMS, fax, voice mail is obtained from an external power supply, said external power supply is a battery, and the said code comparer is operated with Integrated Chips within low power consumption obtained from the external power supply in the server database of SMS or MMS, and the operation of low power consumption of Integrated Chips are operate continuously the function of said code comparer for a very long time and the operation of low power consumption of Integrated Chips to save the power consumption of said code comparer in the server database of SMS or MMS.

15. An electronic device comprising a code comparer as claimed in claim 12, wherein, the power supply required to operate the said device in the mobile phone handset, fixed wireless phone and other wireless phones which includes palm operating system based mobile phone, windows operating system based mobile smart phone is obtained from the battery of the mobile phone handset, fixed wireless phone and other wireless phones which includes palm operating system based mobile phone, windows operating system based mobile smart phone, and the said code comparer is operated with Integrated Chips within low power consumption obtained from the battery of the Mobile phone and the operation of low power consumption of Integrated Chips to save the power consumption of said code comparer in the mobile phone.

16. An electronic device comprising a code comparer as claimed in claim 12, wherein,
(a) the unwanted numbers and/or words of the SMS, MMS, E-mail, phone call, voice SMS, voice MMS, fax, voice mail and other communication includes cell mail, mobile mail is sent using SMS or any other suitable settings from the mobile phone, fixed wireless phone and other wireless phones which includes palm operating system based mobile phone, windows operating system based mobile smart phone to the server database of SMS service center, MMS service center and other communication service center which includes Serving GPRS Support Node (SGSN), Mobile Services Switching Center (MSC), E-mail, phone call, voice SMS, voice MMS, fax, voice mail through the respective mobile service provider; more than one unwanted numbers and/or words of the SMS, MMS, E-mail, phone call, voice SMS, voice MMS, fax, voice mail and other communication includes cell mail, mobile mail is sent from the mobile phone, fixed wireless phone and other wireless phones which includes palm operating system based mobile phone, windows operating system based mobile smart phone to the server database of SMS service center, MMS service center and other communication service center which includes Serving GPRS Support Node (SGSN), Mobile Services Switching Center (MSC), E-mail, phone call, voice SMS, voice MMS, fax, voice mail; the numbers and/or words of the incoming SMS, MMS, E-mail, phone call, voice SMS, voice MMS, fax, voice mail and other modes of communication which includes cell mail, mobile mail sent by a sender is sent to the code comparer of the respective server database, the unwanted numbers and/or words of the SMS, MMS, E-mail, phone call, voice SMS, voice MMS, fax, voice mail and other communication includes cell mail, mobile mail that are sent by mobile phone, fixed wireless phone and other wireless phones which includes palm operating system based mobile phone, windows operating system based mobile smart phone are stored in the code comparer memory device,
(b) the numbers and/or words of the incoming SMS, MMS, E-mail, phone call, voice SMS, voice MMS, fax, voice mail and other modes of communication which includes cell mail, mobile mail sent by a sender is compared with the stored unwanted numbers and/or words in the memory device as in step (a) by the code comparer,
(c) when the numbers and/or words that is compared in the code comparer are same as in step (b), then the numbers and/or words of the incoming SMS, MMS, E-mail, phone call, voice SMS, voice MMS, fax, voice mail and other communication includes cell mail, mobile mail is blocked or deleted in the respective server database, and
(d) when the numbers and/or words that is compared in the code comparer is different as in step (b), then the numbers and/or words of the incoming SMS, MMS, E-mail, phone call, voice SMS, voice MMS, fax, voice mail and other communication includes cell mail, mobile mail is sent to the respective number.

17. An electronic device comprising a code comparer as claimed in claim 12, wherein,
(a) the numbers and/or words of the incoming SMS, MMS, E-mail, phone call, voice SMS, voice MMS, fax, voice mail and other modes of communication which includes cell mail, mobile mail is received in the mobile phone handset, fixed wireless phone and other wireless phones which includes palm operating system based mobile phone, windows operating system based mobile smart phone, the code comparer compares the numbers and/or words of the received SMS, MMS, E-mail, phone call, voice SMS, voice MMS, fax, voice mail and other communication includes cell mail, mobile mail with the list of unwanted numbers and/or words of the SMS, MMS, E-mail, phone call, voice SMS, voice MMS, fax, voice mail and other communication includes cell mail, mobile mail which is already stored in the memory device of mobile phone handset, fixed wireless phone and other wireless phones which includes palm operating system based mobile phone, windows operating system based mobile smart phone,
(b) when the numbers and/or words that is compared in the code comparer is same as in step (a), then the numbers and/or words of the received SMS, MMS, E-mail, phone call, voice SMS, voice MMS, fax, voice mail and other communication includes cell mail, mobile mail is blocked or deleted in the receiving set, and
(c) when the numbers and/or words that is compared in the code comparer is different as in step (a), then the numbers and/or words of the received SMS, MMS, E-mail, phone call, voice SMS, voice MMS, fax, voice mail and other communication includes cell mail, mobile mail is indicated in the display screen of the receiving set and the alert tone of the received SMS, MMS, E-mail, phone call, voice SMS, voice MMS, fax, voice mail and other communication includes cell mail, mobile mail is activated.

18. An electronic device comprising a code comparer as claimed in claim 12, wherein,
(a) the wanted numbers and/or words of the SMS, MMS, E-mail, phone call, voice SMS, voice MMS, fax, voice mail and other communication includes cell mail, mobile mail is sent using SMS or any other suitable settings from the mobile phone, fixed wireless phone and other wireless phones which includes palm operating system based mobile phone, windows operating system based mobile smart phone to the server database of SMS service center, MMS service center and other communication service center which includes Serving GPRS Support Node (SGSN), Mobile Services Switching Center (MSC), E-mail, phone call, voice SMS, voice MMS, fax, voice mail through the respective mobile service provider; more than one wanted numbers and/or words of the SMS, MMS, E-mail, phone call, voice SMS, voice MMS, fax, voice mail and other communication includes cell mail, mobile mail is sent from the mobile phone, fixed wireless phone and other wireless phones which includes palm operating system based mobile phone, windows operating system based mobile smart phone to the server database of SMS service center, MMS service center and other communication service center which includes Serving GPRS Support Node (SGSN), Mobile Services Switching Center (MSC), E-mail, phone call, voice SMS, voice MMS, fax, voice mail; the numbers and/or words of the incoming SMS, MMS, E-mail, phone call, voice SMS, voice MMS, fax, voice mail and other modes of communication which includes cell mail, mobile mail sent by a sender is sent to the code comparer of the respective server database, the wanted numbers and/or words of the SMS, MMS, E-mail, phone call, voice SMS, voice MMS, fax, voice mail and other communication includes cell mail, mobile mail that are sent by mobile phone, fixed wireless phone and other wireless phones which includes palm operating system based mobile phone, windows operating system based mobile smart phone are stored in the code comparer memory device,
(b) the numbers and/or words of the incoming SMS, MMS, E-mail, phone call, voice SMS, voice MMS, fax, voice mail and other modes of communication which includes cell mail, mobile mail sent by a sender is compared with the stored wanted numbers and/or words in the memory device as in step (a) by the code comparer,
(c) when the numbers and/or words that is compared in the code comparer are same as in step (a), then the numbers and/or words of the incoming SMS, MMS, E-mail, phone call, voice SMS, voice MMS, fax, voice mail and other communication includes cell mail, mobile mail is sent to the respective number, and
(d) when the numbers and/or words that is compared in the code comparer is different as in step (a), then the numbers and/or words of the incoming SMS, MMS, E-mail, phone call, voice SMS, voice MMS, fax, voice mail and other communication includes cell mail, mobile mail is blocked or deleted in the respective server database.

19. An electronic device comprising a code comparer as claimed in claim 12, wherein,
(a) the numbers and/or words of the incoming SMS, MMS, E-mail, phone call, voice SMS, voice MMS, fax, voice mail and other modes of communication which includes cell mail, mobile mail is received in the mobile phone handset, fixed wireless phone and other wireless phones which includes palm operating system based mobile phone, windows operating system based mobile smart phone, the code comparer compares the numbers and/or words of the received SMS, MMS, E-mail, phone call, voice SMS, voice MMS, fax, voice mail and other communication includes cell mail, mobile mail with the list of wanted numbers and/or words of the SMS, MMS, E-mail, phone call, voice SMS, voice MMS, fax, voice mail and other communication includes cell mail, mobile mail which is already stored in the memory device of mobile phone handset, fixed wireless phone and other wireless phones which includes palm operating system based mobile phone, windows operating system based mobile smart phone,
(b) when the numbers and/or words that is compared in the code comparer is same as in step (a), then the numbers and/or words of the received SMS, MMS, E-mail, phone call, voice SMS, voice MMS, fax, voice mail and other communication includes cell mail, mobile mail is indicated in the display screen of the receiving set and the alert tone of the received SMS, MMS, E-mail, phone call, voice SMS, voice MMS, fax, voice mail and other communication includes cell mail, mobile mail is activated, and
(c) when the numbers and/or words that is compared in the code comparer is different as in step (a), then the numbers and/or words of the received SMS, MMS, E-mail, phone call, voice SMS, voice MMS, fax, voice mail and other communication includes cell mail, mobile mail is blocked or deleted in the receiving set.

20. An electronic device comprising a code comparer as claimed in claim 12, wherein,
(a) the unwanted and the wanted numbers and/or words of the SMS, MMS, E-mail, phone call, voice SMS, voice MMS, fax, voice mail and other communication includes cell mail, mobile mail is sent using SMS or any other suitable settings from the mobile phone, fixed wireless phone and other wireless phones which includes palm operating system based mobile phone, windows operating system based mobile smart phone to the blocking database and receiving database in the server database of SMS service centre, MMS service centre and other communication service centre which includes Serving GPRS Support Node (SGSN), Mobile Services Switching Centre (MSC), E-mail, phone call, voice SMS, voice MMS, fax, voice mail through the respective mobile service provider,
(b) more than one unwanted and wanted numbers and/or words of the SMS, MMS, E-mail, phone call, voice SMS, voice MMS, fax, voice mail and other communication includes cell mail, mobile mail is sent from the mobile phone, fixed wireless phone and other wireless phones which includes palm operating system based mobile phone, windows operating system based mobile smart phone to the blocking database and receiving database in the server database of SMS service centre, MMS service centre and other communication service centre which includes Serving GPRS Support Node (SGSN), Mobile Services Switching Centre (MSC), E-mail, phone call, voice SMS, voice MMS, fax, voice mail; the same numbers and/or words of the SMS, MMS, E-mail, phone call, voice SMS, voice MMS, fax, voice mail and other communication includes cell mail, mobile mail is sent from the mobile phone, fixed wireless phone and other wireless phones which includes palm operating system based mobile phone, windows operating system based mobile smart phone to the blocking database and receiving database in the server database of SMS service centre, MMS service centre and other communication service centre which includes Serving GPRS Support Node (SGSN), Mobile Services Switching Centre (MSC), E-mail, phone call, voice SMS, voice MMS, fax, voice mail, then a message example; Error number is automatically sent to the mobile phone, fixed wireless phone and other wireless phones which includes palm operating system based mobile phone, windows operating system based mobile smart phone from the server database of respective service centre of the mobile service provider,
(c) the numbers and/or words of the incoming SMS, MMS, E-mail, phone call, voice SMS, voice MMS, fax, voice mail and other modes of communication which includes cell mail, mobile mail sent by a sender is sent to the code comparer of the respective server database, the unwanted and the wanted numbers and/or words of the SMS, MMS, E-mail, phone call, voice SMS, voice MMS, fax, voice mail and other communication includes cell mail, mobile mail that are sent by mobile phone, fixed wireless phone and other wireless phones which includes palm operating system based mobile phone, windows operating system based mobile smart phone are stored in the code comparer memory device,
(d) the code comparer compares the numbers and/or words of the incoming SMS, MMS, E-mail, phone call, voice SMS, voice MMS, fax, voice mail and other modes of communication which includes cell mail, mobile mail sent by a sender, with the unwanted and the wanted numbers and/or words of the SMS, MMS, E-mail, phone call, voice SMS, voice MMS, fax, voice mail and other communication includes cell mail, mobile mail that is already stored in the memory device, which is sent by the mobile phone, fixed wireless phone and other wireless phones which includes palm operating system based mobile phone, windows operating system based mobile smart phone,
(e) a new option is Active and Deactive is provided in the server database of the SMS service centre, MMS service centre and other communication service centre which includes Serving GPRS Support Node (SGSN), Mobile Services Switching Centre (MSC), E-mail, phone call, voice SMS, voice MMS, fax, voice mail which is set,
(f) when the numbers and/or words of the incoming SMS, MMS, E-mail, phone call, voice SMS, voice MMS, fax, voice mail and other modes of communication which includes cell mail, mobile mail that is compared in the blocking database of code comparer is different, then the numbers and/or words of the incoming SMS, MMS, E-mail, phone call, voice SMS, voice MMS, fax, voice mail and other communication includes cell mail, mobile mail is sent to the respective number,
(g) when the numbers and/or words of the incoming SMS, MMS, E-mail, phone call, voice SMS, voice MMS, fax, voice mail and other modes of communication which includes cell mail, mobile mail that is compared in the blocking database of code comparer is same; then the numbers and/or words of the incoming SMS, MMS, E-mail, phone call, voice SMS, voice MMS, fax, voice mail and other modes of communication which includes cell mail, mobile mail that is compared in the receiving database of code comparer,
(h) when the numbers and/or words of the incoming SMS, MMS, E-mail, phone call, voice SMS, voice MMS, fax, voice mail and other modes of communication which includes cell mail, mobile mail that is compared in the receiving database of code comparer is same; then the numbers and/or words of the incoming SMS, MMS, E-mail, phone call, voice SMS, voice MMS, fax, voice mail and other communication includes cell mail, mobile mail is sent to the respective number, and
(i) when the numbers and/or words of the incoming SMS, MMS, E-mail, phone call, voice SMS, voice MMS, fax, voice mail and other modes of communication which includes cell mail, mobile mail that is compared in the receiving database of code comparer is different; then the numbers and/or words of the incoming SMS, MMS, E-mail, phone call, voice SMS, voice MMS, fax, voice mail and other communication includes cell mail, mobile mail is operated based on the New option is Active or Deactive as set in the respective server database.

21. An electronic device comprising a code comparer as claimed in claim 12, wherein,
(a) the numbers and/or words of the incoming SMS, MMS, E-mail, phone call, voice SMS, voice MMS, fax, voice mail and other modes of communication which includes cell mail, mobile mail is received in the mobile phone handset, fixed wireless phone and other wireless phones which includes palm operating system based mobile phone, windows operating system based mobile smart phone, the code comparer compares the numbers and/or words of the received SMS, MMS, E-mail, phone call, voice SMS, voice MMS, fax, voice mail and other communication includes cell mail, mobile mail with the list of unwanted and wanted numbers and/or words of the SMS, MMS, E-mail, phone call, voice SMS, voice MMS, fax, voice mail and other communication includes cell mail, mobile mail which is already stored in the memory device of mobile phone handset, fixed wireless phone and other wireless phones which includes palm operating system based mobile phone, windows operating system based mobile smart phone,
(b) when the numbers and/or words that is compared in the blocking database of the code comparer is different; then the numbers and/or words of the received SMS, MMS, E-mail, phone call, voice SMS, voice MMS, fax, voice mail and other communication includes cell mail, mobile mail is indicated in the display screen of the receiving set and the alert tone of the received SMS, MMS, E-mail, phone call, voice SMS, voice MMS, fax, voice mail and other communication includes cell mail, mobile mail is activated,
(c) when the numbers and/or words that is compared in the blocking database of the code comparer is same; then the numbers and/or words that is compared in the receiving database of the code comparer,
(d) when the numbers and/or words that is compared in the receiving database of the code comparer is same; then the numbers and/or words of the received SMS, MMS, E-mail, phone call, voice SMS, voice MMS, fax, voice mail and other communication includes cell mail, mobile mail is indicated in the display screen of the receiving set and the alert tone of the received SMS, MMS, E-mail, phone call, voice SMS, voice MMS, fax, voice mail and other communication includes cell mail, mobile mail is activated, and
(e) when the numbers and/or words that is compared in the receiving database of the code comparer is different; then the numbers and/or words of the received SMS, MMS, E-mail, phone call, voice SMS, voice MMS, fax, voice mail and other communication includes cell mail, mobile mail is operated based on the new message option is Active or Deactive as selected in the Sub-Menu of the mobile phone handset, fixed wireless phone and other wireless phones which includes palm operating system based mobile phone, windows operating system based mobile smart phone.

22. A method of blocking unwanted communication or allowing wanted communication or blocking unwanted communication and allowing wanted communication on an electronic device, comprising:
comparing one or more numbers and/or words of an incoming communication with stored numbers and/or words of the communication in a memory device of a server database of a communication service center or of a mobile phone.
